(19) United States
(12) Patent Application Publication
(10) Pub. No.: US 2026/0099155 A1
(43) Pub. Date: Apr. 9, 2026

(54) ENHANCED FLIGHT MODE

(71) Applicant: Air Vev Ltd, Pardes Hana (IL)

(72) Inventor: Chen ROSEN, Mishmarot (IL)

(73) Assignee: Air Vev Ltd, Pardes Hana (IL)

(21) Appl. No.: 19/115,287

(22) PCT Filed: Sep. 28, 2023
(86) PCT No.: PCT/IL2023/051046

§ 371 Date: Mar. 26, 2025

Related U.S. Application Data
(60) Provisional application No. 63/410,673, filed on Sep. 28, 2022.

(51) Int. Cl. G05D 1/654; G05D 1/485; G05D 105/20; G05D 109/22

(52) U.S. Cl. CPC G05D 1/6545; G05D 1/485; G05D 2105/20; G05D 2109/23

(57) ABSTRACT

During aircraft descent, flight control systems seek and maintain a glide slope determined from a single pilot input parameter; e.g., the position of a control axis of a flight stick. Appropriate guide slope selection by the pilot is readily determined from the pilot's visual observation of an intended landing site during landing approach. The glide slope defines a ratio of forward speed and descent speed which is automatically established and maintained/updated according to pilot input while these speeds are also automatically reduced during descent, despite the two speed directions respectively being affected distinctly and differently by aircraft mechanisms which control them. The aircraft ends its glide path with speed at or near zero, allowing landing by short vertical descent. Accordingly, the pilot offloads problems of both coordinating speeds to achieve a particular guide slope, and reducing them while maintaining this coordination.

### RELATED APPLICATION/S

This application claims the benefit of priority of U.S. Provisional Patent Application No. 63/410,673, filed on Sep. 28, 2022.

The contents of this reference are incorporated herein by reference in their entirety.

### FIELD AND BACKGROUND OF THE INVENTION

The present invention, in some embodiments thereof, relates to the field of aircraft flight control and more particularly, but not exclusively, to flight control during aircraft landing.

Multicopter aircraft designs use a plurality of power source-driven propellers to provide vertical lift and/or horizontal thrust. Multicopters are used and/or proposed for use in a range of applications including cargo and/or passenger transport. Practical multicopters are enabled by technologies such as computerized control and/or sensing electronics, relatively lightweight and powerful electric motors, improvements in battery storage energy-to-weight ratios, and/or improvements to electricity generating using relatively lightweight generators.

Aircraft during flight are controlled in a plurality of orientation axes (e.g., yaw, pitch and roll). They have a forward speed and rate of climb (ROC, which in the case of descent is negative, or a “descent speed”). Overall control of these flight parameters is generally exerted through use of several separately operating aircraft mechanisms. Often, more than one flight mechanism affects a given flight parameter, and a given flight mechanism often affects more than one flight parameter.

### SUMMARY OF THE INVENTION

According to an aspect of some embodiments of the present disclosure, there is provided a method of automatic control of aircraft forward speed and descent speed during descent of the aircraft to a landing site, the method including: adjusting a targeted glide slope of the aircraft in accordance with an updating indication of corrections by a pilot to the targeted glide slope; adjusting automatically a ratio of the speeds to correspond with descent of the aircraft along the targeted glide slope as the targeted glide slope is adjusted; and maintaining the ratio of the speeds in correspondence with the targeted glide slope while automatically reducing the forward speed from an initiating speed to a terminating speed; wherein the initiating speed and terminating speed are different by at least half of the initiating speed of the aircraft.

According to some embodiments of the present disclosure, the terminating speed is less than 10% of the initiating speed of the aircraft.

According to some embodiments of the present disclosure, the terminating speed is stationary.

According to some embodiments of the present disclosure, the initiating speed is at least 80% of a design cruise speed of the aircraft.

According to some embodiments of the present disclosure, the terminating speed is reached upon the aircraft being over the landing site.

According to some embodiments of the present disclosure, the aircraft descends from an initiating height to a terminating height while slowing from the initiating speed to the terminating speed, and the ratio of the initiating height to the terminating height is within a factor of three of the ratio of the initiating speed and the terminating speed.

According to some embodiments of the present disclosure, as a function of height, the forward speed decreases about linearly for at least half of the difference between the initiating height and the terminating height.

According to some embodiments of the present disclosure, as a function of height, deceleration of forward speed includes increasing deceleration for at least 10% of the difference between the initiating height and the terminating height.

According to some embodiments of the present disclosure, as a function of height, deceleration of forward speed includes decreasing deceleration for at least 10% of the difference between the initiating height and the terminating height.

According to some embodiments of the present disclosure, as a function of height, forward speed decreases linearly on average for at least 90% of the difference between the initiating height and the terminating height.

According to some embodiments of the present disclosure, the terminating height is vertically within 2 meters of the landing site.

According to some embodiments of the present disclosure, the terminating height is vertically within 0.5 meters of the landing site.

According to some embodiments of the present disclosure, the terminating speed is less than 2 m/s.

According to some embodiments of the present disclosure, the terminating speed is stationary.

According to some embodiments of the present disclosure, the terminating height and terminating speed are reached at a position over the landing site.

According to some embodiments of the present disclosure, the method includes hovering the aircraft at the position over the landing site.

According to some embodiments of the present disclosure, a time course of the updating indication of corrections includes: a first phase in which the corrections result in modification of the targeted glide slope until a course of the aircraft descending along the targeted glide slope is aimed at the landing site; and a second phase, following the first phase, in which the corrections maintain the course of the aircraft aimed at the landing site and descending along the targeted glide slope.

According to some embodiments of the present disclosure, a time course of the updating indication of corrections includes: a first phase in which the corrections result in modification of the targeted glide slope until a course of the aircraft descending along the targeted glide slope is aimed at a location away from the landing site; and a second phase in which the corrections adjust the course of the aircraft toward the landing site along an adjusted value of the targeted glide slope.

According to some embodiments of the present disclosure, the pilot communicates the updating indication of corrections by adjusting an axis of a flight controller.

According to some embodiments of the present disclosure, the method includes, upon reaching the termination speed: ceasing adjusting the ratio of the speeds to correspond with descent of the aircraft along the targeted glide slope; and using the axis of the flight controller as an indication of a targeted flight parameter other than glide slope.

According to some embodiments of the present disclosure, the targeted flight parameter includes movement of the aircraft along a direction of only one of vertical height and a direction orthogonal to vertical height.

According to some embodiments of the present disclosure, after reaching the terminating speed, the aircraft remains airborne, but height of the aircraft is no longer adjusted according to the updating indication of corrections to the targeted glide slope.

According to some embodiments of the present disclosure, the maintaining the ratio in correspondence with the targeted glide slope moves the plane along a glide path including forward descending motion along a straight line, for periods during which the targeted glide slope remains unchanged, and lateral motion of the aircraft is constant.

According to some embodiments of the present disclosure, the updating indication of corrections and subsequent maintaining the ratio of the speeds in correspondence with the target glide slope produces a glide path which directs the course of the aircraft toward ground locations nearer or further from the aircraft, according to whether the corrections indicates a steeper or shallower target glide slope.

According to some embodiments of the present disclosure, the updating indication of corrections and subsequent maintaining the ratio of the speeds in correspondence with the target glide slope produces a glide path which descends at a relatively higher speed toward the landing site for a relatively steeper targeted glide slope, and a same forward speed.

According to some embodiments of the present disclosure, the updating indication of corrections is determined by the pilot according to a direct view by the pilot of the position of the landing site, at an angle declined by 10° or more from the horizontal.

According to some embodiments of the present disclosure, the updating indication of corrections is determined by the pilot according to a direct view by the pilot of the position of the landing site, at an angle declined by 30° or more from the horizontal.

According to some embodiments of the present disclosure, the direct view by the pilot of the position of the landing site is through a window portion positioned below waist level of the pilot within the aircraft.

According to some embodiments of the present disclosure, the direct view by the pilot of the position of the landing site is through a window portion positioned adjacent, from the viewing perspective of the pilot, to a footrest for the pilot.

According to some embodiments of the present disclosure, the updating indication of corrections is determined by the pilot according to a camera view of the landing site, at an angle declined by 30° or more from the horizontal.

According to an aspect of some embodiments of the present disclosure, there is provided a flight control system of a vertically landing aircraft including a processor and memory including instructions instructing the processor to: adjust a targeted glide slope of the aircraft in accordance with an updating indication of corrections by a pilot to the targeted glide slope; adjust a ratio of forward speed and descent speed to correspond with descent of the aircraft along the targeted glide slope as the targeted glide slope is adjusted; and maintain the ratio in correspondence with the targeted glide slope while automatically reducing the forward speed from an initiating speed to a terminating speed; wherein the initiating speed and terminating speed are different by at least half of the initiating speed.

According to some embodiments of the present disclosure, the flight control system includes the aircraft.

According to some embodiments of the present disclosure, the terminating speed is stationary, and the initiating speed is at least 80% of a design cruise speed of the aircraft.

According to some embodiments of the present disclosure, the aircraft descends from an initiating height to a terminating height while slowing from the initiating speed to the terminating speed, and the ratio of the initiating height to the terminating height is within a factor of three of the ratio of the initiating speed and the terminating speed.

According to some embodiments of the present disclosure, the terminating height and terminating speed are reached at a position over the landing site at which the flight control system maintains the aircraft in a hover.

According to an aspect of some embodiments of the present disclosure, there is provided a method of landing an aircraft by a pilot including: looking in a downward direction out of the aircraft through a forward-positioned window adjacent to a footrest for feet of the pilot; identifying a landing site visible through the forward-positioned window and in the downward direction; and approaching the landing site while reducing speeds and altitudes until the aircraft lands at the landing site with a stationary forward speed.

According to some embodiments of the present disclosure, the approaching is performed while maintaining forward speed and descent speed in a ratio establishing a glide slope directing the aircraft at the landing site.

According to some embodiments of the present disclosure, the approaching is performed while reducing forward speed as a function of decreasing vertical distance to the landing site.

According to an aspect of some embodiments of the present disclosure, there is provided an aircraft including: a lower-forward positioned window including a region positioned below the waist of an upright seated pilot during level forward flight of the aircraft; and illumination positioned to project one or more target indications to the vision of the pilot, using the window as a reflection surface.

According to an aspect of some embodiments of the present disclosure, there is provided a method of flying an aircraft, including: providing a first sequence of flight direction indications to the aircraft using motions of a flight controller along an axis, wherein the first sequence of flight direction indications control a glide slope setting used to determine a glide path of the aircraft; and providing a second sequence of flight direction indications to the aircraft using motions of the flight control along the same axis, wherein the second sequence of flight direction indications controls one of the group consisting of: horizontal but not vertical movement of the aircraft, vertical but not horizontal movement of the aircraft, and a pitch of the aircraft, but not horizontal or vertical movement of the aircraft.

According to an aspect of some embodiments of the present disclosure, there is provided a vertically landing aircraft having a computerized flight control system providing an enhanced flight mode for an aircraft, wherein the computerized flight control system maintains a fixed ratio between forward and vertical speeds of the aircraft, while reducing both speeds toward stationary landing speeds as a function of the height above the ground.

According to some embodiments of the present disclosure, the aircraft includes a transparent window oriented to face downward toward the ground from the perspective of an upright-seated pilot of the aircraft, and through which a landing area reached upon reaching stationary speeds is viewed during descent and the speeds reduction.

According to some embodiments of the present disclosure, the aircraft includes a camera oriented to face downward toward the ground; and a display presenting a pilot of the aircraft a view of in which a landing area reached upon reaching stationary speeds is viewed during descent and the speeds reduction.

According to an aspect of some embodiments of the present disclosure, there is provided a computerized flight control system configured to maintain a fixed ratio between forward and vertical speeds of an aircraft, while reducing both speeds toward stationary landing speeds as a function of the height above the ground.

According to some embodiments of the present disclosure, the stationary landing speeds are reached in hover mode upon reaching zero forward speed near zero height.

According to some embodiments of the present disclosure, the fixed ratio selects a position of a target landing area, and the fixed ratio is selected according to adjustments by control stick movements.

According to some embodiments of the present disclosure, the target landing area is adjusted by altering an angle of descent in response to the control stick movements, the altering including replacing the fixed ratio with a ratio corresponding to the altered angle of descent.

According to some embodiments of the present disclosure, the flight control system adjusts the target landing area by changing a rate of descent and/or a forward speed deceleration in response to the replaced fixed ratio.

According to an aspect of some embodiments of the present disclosure, there is provided a method of vertically landing an aircraft, including automatically maintaining a fixed ratio between forward and vertical speeds of the aircraft, while reducing both speeds toward stationary landing speeds as a function of the height above the ground.

Unless otherwise defined, all technical and/or scientific terms used herein have the same meaning as commonly understood by one of ordinary skill in the art to which the present disclosure pertains. Although methods and materials similar or equivalent to those described herein can be used in the practice or testing of embodiments of the present disclosure, exemplary methods and/or materials are described below. In case of conflict, the patent specification, including definitions, controls. In addition, the materials, methods, and examples are illustrative only and are not intended to be necessarily limiting.

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, microcode, etc.) or an embodiment combining software and hardware aspects that may all generally be referred to herein as a “circuit,” “module” or “system” (e.g., a method may be implemented using “computer circuitry”).

Furthermore, some embodiments of the present disclosure may take the form of a computer program product embodied in one or more computer readable medium(s) having computer readable program code embodied thereon. Implementation of the method and/or system of some embodiments of the present disclosure can involve performing and/or completing selected tasks manually, automatically, or a combination thereof. Moreover, according to actual instrumentation and equipment of some embodiments of the method and/or system of the present disclosure, several selected tasks could be implemented by hardware, by software or by firmware and/or by a combination thereof, e.g., using an operating system.

For example, hardware for performing selected tasks according to some embodiments of the present disclosure could be implemented as a chip or a circuit. As software, selected tasks according to some embodiments of the present disclosure could be implemented as a plurality of software instructions being executed by a computer using any suitable operating system. In some embodiments of the present disclosure, one or more tasks performed in method and/or by system are performed by a data processor (also referred to herein as a “digital processor”, in reference to data processors which operate using groups of digital bits), such as a computing platform for executing a plurality of instructions. Instruction executing elements of the processor may comprise, for example, one or more microprocessor chips, ASICs, and/or FPGAs. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well. Any of these implementations are referred to herein more generally as instances of computer circuitry.

Any combination of one or more computer readable medium(s) may be utilized for some embodiments of the present disclosure. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. A computer readable storage medium may also contain or store information for use by such a program, for example, data structured in the way it is recorded by the computer readable storage medium so that a computer program can access it as, for example, one or more tables, lists, arrays, data trees, and/or another data structure. Herein a computer readable storage medium which records data in a form retrievable as groups of digital bits is also referred to as a digital memory. It should be understood that a computer readable storage medium, in some embodiments, is optionally also used as a computer writable storage medium, in the case of a computer readable storage medium which is not read-only in nature, and/or in a read-only state.

Herein, a data processor is said to be “configured” to perform data processing actions insofar as it is coupled to a computer readable medium to receive instructions and/or data therefrom, process them, and/or store processing results in the same or another computer readable medium. The processing performed (optionally on the data) is specified by the instructions, with the effect that the processor operates according to the instructions. The act of processing may be referred to additionally or alternatively by one or more other terms; for example: comparing, estimating, determining, calculating, identifying, associating, storing, analyzing, selecting, and/or transforming. For example, in some embodiments, a digital processor receives instructions and data from a digital memory, processes the data according to the instructions, and/or stores processing results in the digital memory. In some embodiments, “providing” processing results comprises one or more of transmitting, storing and/or presenting processing results. Presenting optionally comprises showing on a display, indicating by sound, printing on a printout, or otherwise giving results in a form accessible to human sensory capabilities.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present disclosure may be written in any combination of one or more programming languages, including an object-oriented programming language such as Java, Smalltalk, C++ or the like and conventional procedural programming languages, such as the “C” programming language or similar programming languages. Additionally or alternatively, sequences of logical operations (optionally logical operations corresponding to computer instructions) may be embedded in the design of an ASIC and/or in the configuration of an FPGA device. The program code may execute entirely on the user's computer, partly on the user's computer (e.g., as a stand-alone software package), partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present disclosure may be described below with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer; and may not be feasible or practical for performing purely manually, by a human expert. A human expert who wanted to manually perform similar tasks, such inspecting objects, might be expected to use completely different methods, e.g., making use of expert knowledge and/or the pattern recognition capabilities of the human brain, which would be vastly more efficient than manually going through the steps of the methods described herein.

### BRIEF DESCRIPTION OF THE SEVERAL VIEWS OF THE DRAWING/S

Some embodiments of the present disclosure are herein described, by way of example only, with reference to the accompanying drawings. With specific reference now to the drawings in detail, it is stressed that the particulars shown are by way of example, and for purposes of illustrative discussion of embodiments of the present disclosure. In this regard, the description taken with the drawings makes apparent to those skilled in the art how embodiments of the present disclosure may be practiced.

In the drawings:

FIG. 1 schematically illustrates automatic control of relative rate of claim (ROC) and forward speed to maintain a glide slope during the landing approach of a vertically landing aircraft to a targeted landing site within landscape, according to some embodiments of the present disclosure;

FIG. 2A schematically illustrates a range of elevation angles available for direct visual selection of a landing site, according to some embodiments of the present disclosure;

FIG. 2B schematically illustrates relationships among horizontal (forward speed) and vertical (descent) speeds for a glide slope constant k, according to some embodiments of the present disclosure;

FIG. 2C schematically illustrates direct-stick adjustment of glide slope constant k from the perspective of a cockpit of an aircraft, according to some embodiments of the present disclosure;

FIG. 2D illustrates equations relating forward speed v_{H}, ROC v_{V}, aircraft height h (height above landing zone), glide slope constant k, and velocity function ƒ(h), according to some embodiments of the present disclosure;

FIG. 3A schematically illustrates relationships of ground speed to height during landing approach of a vertically landing aircraft, according to some embodiments of the present disclosure;

FIG. 3B schematically illustrates relationships of descent speed (negative ROC) to height during landing approach of a vertically landing aircraft, according to some embodiments of the present disclosure;

FIGS. 4A-E schematically illustrate phases of a landing approach of a vertically landing aircraft, according to some embodiments of the present disclosure;

FIG. 5 is a schematic flowchart of a method of controlling the landing approach of a vertically landing aircraft, according to some embodiments of the present disclosure; and

FIG. 6 schematically illustrates a flight control system of a vertically landing aircraft, according to some embodiments of the present disclosure.

### DESCRIPTION OF SPECIFIC EMBODIMENTS OF THE INVENTION

The present invention, in some embodiments thereof, relates to the field of aircraft flight control and more particularly, but not exclusively, to flight control during aircraft landing.

### Overview

### Landing Control

A broad aspect of some embodiments of the present disclosure relates to systems and methods of flight landing guidance. Under typical aircraft control schemes, high demands are placed on manual coordination to simultaneously control rate of descent with respect to height above ground, forward speed, approach direction and destination during approach in a vertically landing air vehicle.

To land at a controlled airfield, existing systems typically involve selection of a geographic location from a list or a map, followed by suitable adjustments of the map and/or aircraft controls to perform landing itself, e.g., along a runway and/or upon a landing pad, generally performed according to protocols exchanging requests and permissions. Controlled airfield landing is particularly well-suited to automation, insofar as airfield conditions are actively monitored and maintained to facilitate safe aircraft operation.

Under other scenarios, however, a landing site may be chosen more-or-less spontaneously, and/or a chosen landing site may be in an unknown and/or variable condition. This may be true particularly for the landing sites of sport aircraft. Short/vertical takeoff or landing (SVTOL) aircraft allow particularly versatile selection of landing sites. For example: going for a picnic on a hill-located site spotted from the air involves landing skills and methods different from those of a controlled airfield. Such an aircraft may be, for example, a helicopter or multirotor aircraft.

One potential method for landing on a site operates indirectly through setting up parameters of an automated and/or automated-assist landing system from a map. Following from the previous example, the hill is found on an electronic map (e.g., relative to current location), and a navigation system instructed that this is the landing destination. However, this creates a layer of indirection between visual site identification and landing site identification, insofar as the map location may be identified incorrectly; and/or the map itself may be incomplete, out of date, and/or otherwise incorrect. Furthermore, the landing site, even if properly identified as to location, may be insufficiently characterized to allow confident automatic landing. There may be obstacles, temporary (e.g., livestock) and/or permanent (e.g., fencing, boulders, cables, and/or trees) which are unknown to the navigation system, and/or undetected by the automatic landing system.

Accordingly, setting up common automated systems (e.g., portable-device accessed navigation map systems relying on GPS signals) for navigation to a landing site may involve potential hazards: there is risk in selecting a point to land at on a map (e.g., one can make a mistake reading the map, or the map may not be updated and have a new obstacle that wasn't there before (like a sheep that stands on the hill, not showing in the map).

For safety, then, a pilot preferably approaches the landing site in a manner that allows verifying the suitability and safety of the landing site and its surroundings, while maintaining a margin to identify and maneuver away from obstacles and conditions which interfere with landing and/or endanger the aircraft. Risk naturally tends to increase near the ground. It is the locus of multiple potential irregularities, there is a lot of it to collide with—and as it gets closer, there is less time to react. It is, accordingly, a potential advantage to safely and gradually reduce both height and speed on approach, while maintaining eye contact with the landing location. A pilot may, for example, maneuver visually, while looking from the aircraft to the target landing site outside.

However, aircraft have many degrees of control freedom: for example, control surface positions and/or power levels of different motors. At the same time, control operation may affect the aircraft in complex ways that often affect more than one aspect of flight dynamics: velocity and pitch may be affected together, for example; and a same given pilot input may have different effects depending on the current dynamic state of the aircraft (e.g., hovering vs. rapid forward flight), and/or the current environment (e.g., turbulence and/or cross-winds). This potentially raises the complexity of efficiently reaching the targeted landing site without overshoot, and with the aircraft in a safe dynamic state (e.g., not too fast or otherwise near or beyond safe limits on performance, responsiveness, and/or pilot perception and/or reaction time).

### Pilot-Selected Glide Slope

An aspect of some embodiments of the present disclosure relates to systems and methods of flight landing which promote aircraft glide slope to an input parameter directly controlled by the pilot. In some embodiments, glide slope is mapped to the positioning of a primary pilot control apparatus, for example and preferably a control axis of a flight stick (flight controller). In some embodiments, the axis used to control glide slope is switchable among between a plurality of functions over the course of a flight depending on flight mode. For example, it may also be used as an altitude control (e.g., during cruising flight) and/or as a forward/backward position control (e.g., for fine adjustment of position over a landing site while hovering).

Herein, an “axis” of a flight stick/flight controller refers to a control axis providing an output which is variable between extremes through a range of other states, e.g., comprising at least a center state of the range and on either side of the center value a respective plurality of distinguishable states. For example, a typical digital control axis may output integer values in a range of 8 bits (0-255) or 16 bits (0-65535), optionally truncated at one or both sides of the range or with a dead zone. Use of a non-digital control axis (e.g., resistance and/or voltage level based) is not excluded. The pilot may perceive the control axis as being continuous in value between its extremes. The control axis is not necessarily implemented as a flight stick axis; e.g., it may be implemented as a slider. It is not excluded that the pilot input is by means other than a control axis; e.g., a toggle switch or push button arrangement with commanded slope changes and/or velocity of slope changes proportional to duration of presses and/or number of presses.

The mapping of the pilot input to an indication of (targeted) glide slope is optionally through any suitable procedure and/or apparatus. In a simple example, the mapping may be a lookup table indexing raw control axis values to glide slopes. However, a flight computer 651 may maintain an internal representation of targeted glide slope, set and/or adjusted relatively according to how the pilot input device is operated.

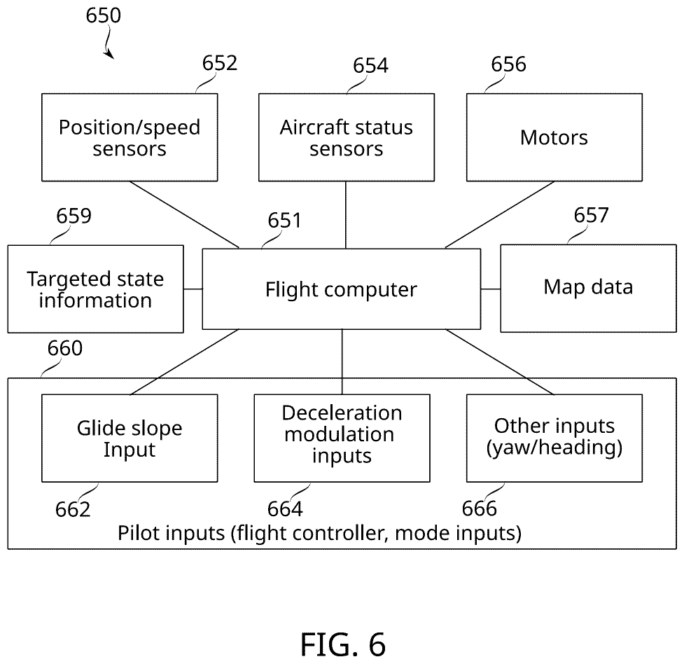

In some embodiments, accordingly, there is provided an enhanced flight mode used for a vertically landing aircraft, helicopter or multirotor, where the computerized flight control system (e.g., flight control system 650 of FIG. 6) maintains a fixed ratio between the forward and vertical speeds, while reducing both speeds as a function of the height above the ground. The ratio is fixed by the present glide slope which the pilot selects and optionally changes during the approach to landing. Herein, reference to forward speed should be understood as forward ground speed (that is, speed relative to the earth's surface).

The corresponding method of using the enhanced flight mode creates a linear glide slope which makes it easy for the pilot to estimate the exact position of landing during the approach, and eliminates the workload associated with reducing approach speed towards landing while maintaining a glide slope. While this capability has particular uses for landing at sites without controlled approaches, it optionally is also used for descent to controlled-approach landing sites, e.g., in accordance with airstrip-provided landing guidance devices and/or flight traffic controller instructions.

Direct (optionally and preferably single-axis) pilot control of glide slope potentially reduces control complexity for the pilot by removing the need to coordinately manage forward speed and rate of descent through separate operation of their respectively controlling aircraft sub-systems. To maintain the pilot-selected glide slope, horizontal (forward speed) and vertical (rate of descent) aircraft speeds are automatically adjusted to maintain a ratio compatible with the currently selected glide slope (e.g., the tangent of its angle). For example, with a 45° declination glide slope, the rate of forward speed and the rate of descent are the same. With a 10° declination glide slope, the forward speed is about 5.8× the rate of descent. Optionally, the landing glide path may begin from any initial speed attained by the aircraft. Initial speed upon beginning glide slope control mode is commonly from at least 80% of the aircraft's design cruise speed (which may be e.g., in a range of 80-120 knots, for example, 90 knots, other values not excluded). Optionally, glide path may begin (within constraints, e.g., of aircraft performance) from any initial forward speed or descent speed of the aircraft (absolute, or relative to its design cruise speed). The forward speed at which the pilot begins providing direct glide slope inputs during descent is also referred to herein as the “initiating speed” (of the aircraft).

It is noted that forward speed definitions other than forward ground speed (e.g., forward air speed) generally lack the property of placing a visually sited target landing site at the end of the glide slope. However, correction of forward air speed measurements to forward ground speed may be made as appropriate. Optionally, the difference is ignored (e.g., at high altitudes/high speeds), though this is expected to result in an offset needing continuing pilot correction to inputs, especially as the relative contribution of wind speed offset increases with decreasing forward speed.

Optionally, the landing glide path may begin from any initial altitude attained by the aircraft. Initial altitude upon beginning the glide path may be, for example, in a range from 100-2000 m, or otherwise as appropriate, e.g., depending on characteristics of aircraft and/or flight plan such as cruising altitude. From 2000 m, for example, a glide slope of 10° leads to a landing site over about 11.5 km; a glide slope of 60° over about 0.5 km. Glide slopes initiated from other altitudes adjust in proportion.

The altitude at which the pilot begins providing direct glide slope inputs during descent (the beginning of glide slope control mode) is also referred to herein as the “initiating height”.

In an idealized case: once the glide path is aligned to the landing site, the aircraft may follow a constant glide slope down to reach it, at speeds varying, e.g., as a function of height above ground. For example, the speed during the approach can be reduced as a function of height above ground down to a stationary speed, so the air vehicle enters stationary hover above or just before the landing point. From a stationary speed, preferably zero, commencement of operations to land (vertically or nearly vertically) may begin. Other functions of height and/or other parameters are explained below. In some embodiments, commencement of vertical operations to land comprises leaving glide slope control mode. This may comprise remapping a pilot control previously used as the glide slope indication to a different function; e.g., control of height as such, or forward/backward positioning over a landing site.

Since glide slope is what the pilot controls (and so may correct as well), it is not necessarily preserved as a constant during the whole of the landing approach. Optionally, it is corrected during any part of the landing approach. Preferably, it is open to updating correction during the whole of landing approach as long as glide slope control mode remains active. “Updating correction” means that the system repeatedly accesses a state of a pilot-controlled indication such as a flight controller axis position, and uses that indication to adjust (e.g., calculate) a currently targeted glide slope of the aircraft.

During the approach the pilot can use controls to modify the glide slope in an intuitive manner—wherein the controls actually move the landing point by making the glide slope steeper, shallower, change heading and/or move the entire glide-slope (optionally without changing heading) sideways.

For example, the pilot may initially choose an incorrect glide slope, and/or the glide slope upon initiation of landing approach mode may not be appropriate to the intended landing site. The pilot may change the landing site, and/or select the landing site more precisely (and optionally incrementally) as its general area approaches and can be viewed more clearly. At higher speeds (e.g. to slow increases in cabin air pressure, and/or to allow maintaining a safe high speed for a greater distance of the journey), it may not be desirable to fully decline the glide slope to the “average” glide slope needed for landing, in preference to establishing a sharper descent after the aircraft has slowed. Conversely, a steep and high-speed initial descent phase may be the pilot's preference, e.g., for the sake of inspecting (or simply experiencing) the landscape more closely. Control and/or sensing inaccuracies potentially generate drift that induces the pilot to modify glide slope, e.g., inaccuracies in sensing ground speed and/or correcting for winds. Any of these variations may be compensated for naturally as the pilot provides inputs which direct the aircraft back toward a visually selected landing site.

### Pilot Observation of Landing Site

Particularly with suitable airframe design, other aspects of control to maintain a suitable glide path are potentially experienced by the pilot as intuitive, and/or are suitable to automatic control with minimized risk. E.g., in some embodiments, the system automates approach to a landing site in an intuitive way which remains under the control of the pilot.

“Suitable airframe design”, in some embodiments, comprises design which allows the pilot to make direct observations of the terrain at depressed angles of elevation. For example, the “approach flight mode” (glide slope control mode) can be used for assisted landing maneuvers for glide slopes that are 10° to 60° below the horizon. The slope angle is also determined by the pilot's visibility of the target landing area. The visibility of the final landing spot below the pilot via a window found below his/her legs (or by a camera pointing at the landing spot), is used to trigger and initiate the glide slope approach mode. The glide path is a straight line all the way to a very low altitude hover. Since glide path may be pilot-altered, the actual line of flight may be curved.

It is noted that typical glide slopes of a fixed-wing aircraft during final approach to a runway are considerably shallower than this, e.g., in a range of 3°-5.5° (the latter being already considered rather steep).

In some embodiments, an aircraft which is configured to allow much steeper glide slopes is provided with an observation window positioned substantially at the feet of the pilot; e.g., a window which the pilot's legs and/or feet at least partially occlude from the viewpoint of the pilot.

The observable angle of declination is optionally adjustable by modifying the pitch of the aircraft. Optionally (e.g., when the aircraft is a multirotor craft), the pilot is able to adjust the degree to which aircraft pitch adjustments are coupled to glide slope and/or descent speed. For example, a same glide slope may be achievable with different combinations of aircraft pitch and thruster power. In some embodiments, this is compounded with speed—and angle of attack-dependent effects of wing body lift.

Changes in speed may place constraints on aircraft pitch, e.g., an aircraft may be constrained to fly more horizontally as it slows near the ground to avoid developing excessive forward (horizontal) speed. In some embodiments, glide slope is partially constrained by aircraft pitch, e.g., it is optionally constrained to those angles consistent with maintaining the landing site in view. Such a constraint is optionally applied more strictly nearer to the ground, since that is where greatest certainty is needed. Accordingly, a pilot may choose an initial (steep) glide slow which deliberately undershoots a selected landing site, in order to have a shallower glide slope (and better landing site visibility) during landing itself.

So long as the pilot can observe the terrain at the end-point of the present glide slope, it may be intuitively obvious to them which location on the ground that is (e.g., without required recourse to a map or even an automatic marking provided by the aircraft) simply by observing drift and/or patterns of optical flow in the field of view. Ideally, the present ground target grows but otherwise “remains still” on approach from the angular perspective of the pilot (wherever in that perspective it may be). Everything else flows perceptually outward from that point.

In non-ideal cases (e.g., if there is glide path drift, perhaps due to sideways movement of the aircraft), then adjusting glide slope adjusts the “vertical” (up/down, although also near/far) perceptual axis of the pilot to directly correct such drift, while drift along the “horizontal” perceptual axis (left-right) may be corrected by one or both of adjusting aircraft angle (azimuth) and aircraft lateral velocity.

Having the landing site visually in sight means that the pilot can operate controls to ensure that it (in particular) remains at a fixed angular position with respect to the pilot's perspective. Optionally, keeping the landing area in a fixed position relative to the pilot's eyes (for example, between his legs) is the key for making this glide-slope descent easy for the pilot: the pilot is traveling along a predefined straight line, to the point selected (and monitored) in the window below. Even if the instantaneous flight path is significantly different than the pilot-perceived direction of motion, incremental correction applied by the pilot to stabilize the relative direction of the landing site will generally suffice to maintain the glide path, so long as speeds are sufficiently reduced on closer approach.

Glide-Slope Based Landing Site Indication and/or Selection

Nevertheless, in some embodiments, a display is provided which presents a navigation-computer estimated position of the landing site (e.g., according to present trajectory including glide slope, according to where the ground would be intersected). This may be, e.g., marked as an area and/or position on a map display, and/or a light reflected from a transparency placed in the pilot's measured and/or estimated line of sight so that (for the pilot) it coincides with the angular position of the estimated landing site. In some embodiments, this display comprises a “feet down” reflective display, e.g., a directed illumination beam which scatters/reflects off of a surface of a transparent view port located in a position from the pilot's perspective below the pilot's waist.

Optionally, the navigation system is configured to determine potential landing sites (e.g., zones considered large enough and level enough according to known map information) within a general area toward which the aircraft is being directed, and indicate these (or their absence, optionally including indications of “forbidden” for reasons other than physical suitability) to the pilot as appropriate.

Optionally, the aircraft and pilot interact at least in part through piloting navigation choices to select a specific landing site (e.g., while potentially several are still available). For example, a single site nearest to the currently selected glide path (or otherwise “most appropriate”, e.g., in terms of size and/or level) is highlighted, which the pilot may accept with a button press or other indication (e.g., verbal confirmation). Optionally, a plurality of options generally consistent with the current glide path are presented, and the pilot is allowed to select from among them (e.g., name one verbally, and/or cycle through and select). Landing may then continue with the pilot freely maneuvering the aircraft as they would otherwise (e.g., including via direct selection of glide slope), with the position-selected landing site being displayed to help maintain pilot orientation and/or as a basis for providing warnings. Optionally, the pilot instructs the navigation system to convert the glide-slope-assisted landing site selection to instructions for an at least partially automated landing procedure (e.g., following in along the glide slope to hover above the landing site, adjusting as needed to reach it). The pilot can optionally take over as needed (e.g., again by selecting glide-slope using an axis controller).

Optionally, once a target landing site is selected, the navigation computer and/or pilot and navigation computer working in concert can adopt more indirect navigational strategies to reach the landing site. For example, the pilot can optionally deviate from a direct glide path to the landing site, while the navigation computer keeps the pilot informed as to whether final corrections to prevent overshoot remain within the flight envelope of the aircraft. Optionally, the computer calculates parameters of an optimal path to the selected landing site (e.g., optimal in terms of energy budget, optionally within limiting performance parameters such as rate of descent and/or aircraft pitch), and instruct the pilot as to these parameters (e.g., including suggesting a target glide slope, potentially dynamic during descent, and along which the computer will suitably regulate speeds), and/or guide the aircraft itself according to these parameters. In some embodiments, feedback to the pilot comprises force feedback (e.g., on a flight controller), proportioned according to deviations of pilot-provided course indications from a selected glide slope.

### Speed as a Function of Height

As another aspect of glide path: aircraft speed is automatically reduced, in some embodiments, as a function correlating with decreasing height.

In a conventional aircraft, the final glide can be a straight line, but the forward speed is roughly constant so that a constant rate of descent, maintains a straight line. The difficult part for a human pilot is to keep a straight line WHILE reducing speed (all the way to zero in the case of a vertically landing aircraft), so rate of descent (ROC—Rate Of Climb) needs to constantly be adjusted. Reducing both speed and ROC requires high coordinative effort and involves changing both power and pitch which also affect one another.

During a glide slope control mode or “approach mode”, according to some embodiments of the present disclosure, the aircraft is held on the line (as long as it remains pilot-selected), while reducing speed ALONG THAT LINE (by automatically coordinating both power and pitch), and creating a situation where the stick forward and back motion just changes the angle of the approach line. For the pilot it seems that the stick moves the aiming/target point on the ground. In some embodiments, the speed along the linear descent path is decreased linearly. The pilot starts, for example, with a “default” glide slope, terminating at a certain target or aim point on the ground that the aircraft is heading towards. The pilot only needs to adjust the location of this point on the ground with the flight stick. Besides selection of glide slope, the pilot can change course longitudinally: e.g., by changing bearing and/or moving the aircraft with a sideways component.

Automating (and ensuring) deceleration potentially reduces risks of ground obstacles as such, while also allowing more time for the pilot to react to ground observations and/or aircraft behavior. In any case, eventual reduction of forward (ground) speed to a stationary speed slow enough to initiate final landing (e.g., zero, imperceptible, less than 10 cm/sec, or less than 1 m/sec) is expected to occur at/over the landing site (or at least a site which is being surveyed for suitable landing space by the pilot). Reduction of the rate of descent to stationary (e.g., brief hover at a fixed altitude, or slowing of descent to a low rate of, e.g., 0-100 cm/sec before landing) optionally occurs at any suitable height at or above ground elevation. Preferably, this height is enough to be dependably out of contact with the ground (optionally as determined in view of a potential for unknown ground obstacles), but not excessively high so as to extend hovering time as the aircraft descends. In some embodiments, the target height at minimum descent speed is a few cm (e.g., 10-100 cm); optionally increased to account for wind conditions, objects/irregularities at the landing site, and/or uncertainty about either. The height of the aircraft upon exiting glide slope control mode is also referred to herein as the “terminating height”. Optionally the terminating height is vertically within 0.1 m, 0.5 m, 1 m, or 2 m of the landing site.

Herein, the forward speed of the aircraft upon termination of glide slope control mode is also referred to as the “terminating speed”. In some embodiments, the terminating speed is no more than half the initiating speed of the aircraft, although if the terminating speed is no lower than this, it is expected that the aircraft will not be in an appropriate state for vertical landing without further action. In some embodiments, the terminating speed is less than 10% of the initiating speed of the aircraft. In some embodiments, the terminating speed is less than 2 m/sec, less than 1 m/sec, or less than 0.1 m/sec. Terminating speeds which are stationary speeds (e.g., zero, or stationary in the sense of “permitting station-keeping” by actions of the pilot) are preferable.

Before reaching the landing site itself, the height used is measured, for example, relative to the ground presently below the aircraft, relative to ground elevation at the presently extrapolated intersection of glide path and ground surface, relative to ground elevation at a selected GPS coordinate, and/or relative to a pilot input and/or pilot adjusted (e.g., offset) elevation. In some embodiments, speed adjustments as a function of height are made relative to a static ground height reference. Optionally, the ground height reference is dynamic, but static so long as a particular projected course of flight is maintained. Optionally, the ground height reference is variable along a projected course of flight. Optionally, the ground height reference is constrained to vary relatively slowly (e.g., to avoid inducing sudden velocity adjustments). The ground height reference may be exchanged as needed along the glide path according, e.g., to any of these definitions, as they may change, become available, and/or increase in relevance to the piloting of the aircraft.

Optionally, the maximum elevation in some area of terrain is used as a ground height reference. Optionally, the ground height reference is determined from the terrain in another fashion; e.g., excluding peaks which the course is assumed to avoid. The region of terrain used to determine the ground height reference is optionally selected and/or sized according to the present course. For example, it may be selected as including a projected end-point of the present course. The region's area may be increased at greater speeds, and/or in response to more active maneuvering (e.g., reflecting uncertainty); conversely, it may be decreased with decreasing speed and/or more constant course holding.

The terrain area considered for calculating height optionally includes terrain at and/or between the aircraft's current position and any projected landing site, e.g., at least to prevent collisions with terrain, and optionally to prevent traversal of intervening terrain at low heights with unacceptably high speeds, e.g., more than 50 knots at heights within 20 meters or less of the ground and/or known ground obstacles.

### Height-Dependent Functions and Other Speed Function Parameters

A primary constraint on the height-dependent speed function is that it approaches stationary as the aircraft approaches the hover height targeted to be reached over the landing site. “Stationary” means at least that speed is reduced to the point that the aircraft remains “over the station” of the landing site, allowing landing under human supervision without backtracking.

For example, the aircraft is sufficiently stationary that the pilot can perform station-keeping maneuvers to maintain the aircraft in proximity to the landing site. For example, the pilot, using normal human reaction times, is able, as appropriate, to carry out a plurality of decisions and actions to complete landing from a position over the landing site to a position on the landing site (landed), without leaving the volume over the landing site; the landing site optionally considered as comprising a zone with a diameter of about two aircraft lengths or less. However, embodiments are not limited to switching out of glide slope control mode immediately over the landing site.

In some embodiments, the stationary speed is zero in at least one of the vertical descent speed and forward speed. In some embodiments, speed does not completely reach zero before landing (e.g., landings with a short roll are not excluded), although for vertical landings, at least a brief period of pre-landing hover is expected to be typical. In some embodiments, once the aircraft is close to the ground and landing site, the aircraft may leave glide slope control mode as such, e.g., substituting the last-selected end of the glide path as a targeted ground location, and adjusting speeds as appropriate to reach it, whether or not they match a particular glide slope. This may include switching the pilot's mode of control, for example to direct positioning of the aircraft using forward/backward left/right up/down pilot commands.

For at least some glide slopes, the height-dependent speed function preferably allows maintaining a same fixed ratio of forward air speed to speed of descent over all or nearly all (e.g., at least 90%, 95%, or 99% of the time and/or distance) of a range between initial descent at that ratio of speeds established nearest to full forward cruising speed, and a minimal (e.g., functionally stationary and/or zero) forward speed just before landing. For some glide slopes supported, all or nearly all may not be practical while also maintaining the target site at all times in clear direct view of the pilot; e.g., due to constraints on aircraft pitch. Optionally a camera supplies viewing of the landing site at any stage; but particularly for use upon landing itself, a camera view is optionally provided, e.g., to verify that the ground immediately below the aircraft is clear of obstructions. For some glide slopes supported, the above mentioned all or nearly all may not be practical at all speeds; e.g., a full speed maximum-slope diving descent may be ruled out from certain speeds for reasons of safety and/or aerodynamics, particularly in embodiments for which a wing lifting body is provided. In some embodiments, for heights/velocities at which certain glide slopes are unavailable, the aircraft control system optionally shifts pilot inputs to the nearest available glide slope, and/or otherwise warns and/or corrects the pilot.

In some embodiments, the relationship of height and speed is selected as constrained by limitations on what can be maintained and/or recovered from for one or both of the directions of travel. For example, limits on deceleration are generally different along one axis (forward) than along the other (descent); and in either case they are finite. There may be constraints on aircraft orientation at different speeds and ratios of speeds according to the aerodynamics of airfoil lifting body; e.g., such an airfoil, provided in some embodiments, may function mainly as a brake at lower speeds, while at higher speeds its lifting force limits the independence of through-air direction and aircraft pitch. There are also potentially height-varying constraints as to the importance of maintaining the landing site in the pilot's forward field of view. These may affect which glide slopes are available and/or how aggressively braking maneuvers can be performed.

Within these constraints (and any others of a similar type which may apply), speeds along a glide path for a particular glide slope may optionally be selected as decreasing (preferably monotonically, and at least on average) according to any function of height.

Approximately uniform of deceleration is optional (linear decrease to a projected zero or near-zero speed at the landing site), but not required. In some embodiments, the proportional decrease in forward speed (e.g., between initiating speed and terminating speed) is about equal to the proportional decrease in height Optionally, the two proportional decreases are within a factor of 1.25, 2, 3, or 4 of each other. For example, there may be a “gamma” constant γ which exponentially adjusts the relationship between height (above target height) and forward speed, e.g.,

$$\frac{{v}_{V}}{{v}_{initiating}} = {( \frac{h}{{h}_{initiating}} )}^{γ} ,$$

such that γ=1 represents a linear relationship, and higher/lower values of γ (e.g., in the range of [3⁻¹,3] represent initially slower or initially faster decelerations.

Noted in particular are functions which minimize time-to-landing site, and functions which minimize energy usage to reach the landing site. Constraints may be included to avoid excessively dynamic accelerations at the landing site, e.g., to maintain safety and/or comfort. In some embodiments, less dynamic (slower/more constant deceleration) functions are made available; for example, to reduce needs to change aircraft pitch, and/or otherwise prioritize passenger comfort and/or landing site visibility to the pilot. In some embodiments, deeper glide slopes are associated with deceleration functions which are more aggressively optimized, e.g., for time and/or energy savings, while shallower glide slopes are tilted toward comfort. Optionally, optimization (or another aspect of other height/speed function “style”) is selected (and optionally pilot selectable) independent of glide slope. As an example of “style” as such, a pilot (e.g., one familiar with an area) may prefer sweeping with relatively rapidity down to lower altitudes before a sudden decline in speed and landing; or conversely (e.g., to allow time to select a landing site) a relatively sudden initial slowdown at high altitude, followed by a leisurely descent.

In some embodiments, time, distance and/or another input is used as a parameter which may be viewed as modifying a baseline function-of-height which determines speed. For example if more flight time has elapsed since take off, or there is more distance yet to cover to reach a landing site, energy efficiency may be made a greater priority. These parameters, along with height, are optionally used as proxies for each other, in whole or in part. More distance, once landing mode has commenced, may be considered a proxy for a shallower glide slope, the altitude being otherwise the same. However, landing begun from a lower altitude would generally imply a shorter time/distance to landing. There is, in short, no particular requirement that height as such be the independent variable of the function, or even, strictly speaking, an independent variable. However, “height” is a convenient reference for purposes of description, insofar as landing gives it a determinate final value, and since along a glide slope (or even a monotonically descending glide path), each “height” is visited just once relative to this reference. Accordingly, references herein to speed as a function of height should be understood as exchangeable for equivalences as appropriate. It remains, however, that in controlling glide slope, the pilot perceives also the selection (e.g., along one ground surface axis) of a ground location at which the aircraft's descent is aimed.

Before explaining at least one embodiment of the present disclosure in detail, it is to be understood that the present disclosure is not necessarily limited in its application to the details of construction and the arrangement of the components and/or methods set forth in the following description and/or illustrated in the drawings. Features described in the current disclosure, including features of the invention, are capable of other embodiments or of being practiced or carried out in various ways.

### Parameters of Glide Slope-Controlled Descent to Landing

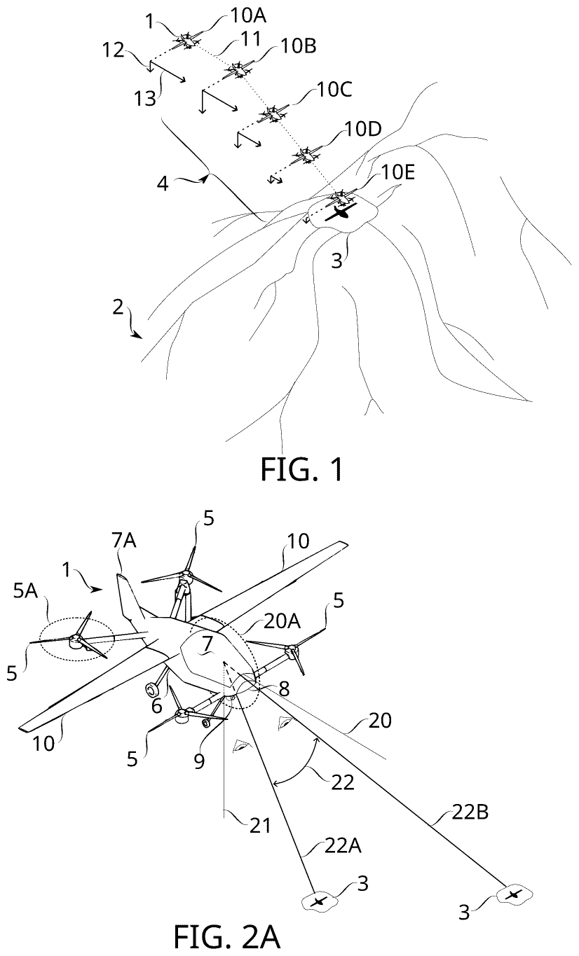

Reference is now made to FIG. 1, which schematically illustrates automatic control of relative rate of claim (ROC) and forward speed to maintain a glide slope during the landing approach of a vertically landing aircraft 1 to a targeted landing site 3 within landscape 2, according to some embodiments of the present disclosure.

At position 10A, the aircraft 1 is in a pre-landing descent phase, with a relatively low descent speed 12 relative to forward speed 13 determining descent slope 11. By the time that aircraft 1 reaches position 10B, the pilot has established vertically landing aircraft 1 on glide slope 4 (somewhat steeper than descent slope 11). Glide slope 4 is maintained through positions 10C, 10D and 10E with decreasing forward speed 13 and descent speed 12; though these are maintained in the same ratio to preserve the same glide slope 4 and remain on target to reach a position at or just above targeted landing site 3.

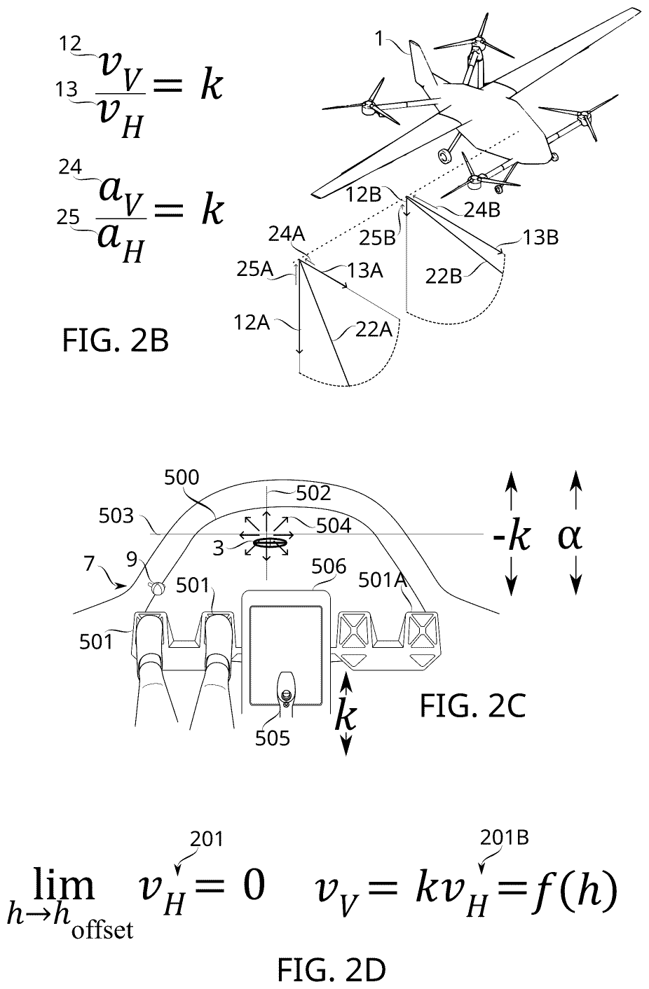

Reference is now made to FIG. 2A, which schematically illustrates a range of elevation angles available for direct visual selection of a landing site 3, according to some embodiments of the present disclosure. Axis 20 represents the direction of forward flight (horizontally), and axis 21 represents the direction of descent (vertically), establishing the pitch plane represented by circle 20A. A typical glide slope lies in range 22, between about 10° (glide slope 22B) and 60° (glide slope 22A) below horizontal. The glide path is not necessarily on the pitch plane 2A as shown, since the aircraft may be experiencing non-zero yaw.

Aircraft 1, in some embodiments, comprises wing 10 and rotors 5.

In some embodiments, wing 10 is a fixed wing providing up to at least 25%-75% of lift at forward cruising speeds of aircraft 1. In some embodiments, wing 10 comprises halves protruding laterally from either side of fuselage 6. Optionally, wing 10 is fixed-shape (e.g., without aerodynamic control surfaces). Other wing configurations are not excluded (e.g., a wing mounted on struts, a bi-wing, and/or a wing with moveable control surfaces).

Also shown is vertical stabilizer 7A. Optionally a split tail configuration is used (e.g., comprising a vertical stabilizer on either part of the split tail). Optionally one or more horizontal stabilizers are provided (e.g., as part of the tail and/or in a canard configuration forward of wing 10).

In some embodiments, thrust is provided by rotors 5. In some embodiments, the rotation plane 5A of the propeller of each of rotors 5 is fixed in orientation relative to the fuselage 6 of aircraft 1. The flight control system of the aircraft optionally adjusts the pitch orientation of aircraft 1 (i.e., angle within the pitch plane represented by circle 20A) as part of adjusting the ratio of horizontal thrust to vertical thrust, and/or as part of adjusting effective overall thrust (e.g., thrust for a fixed rotor speed, as influenced by the angle-selected relative airspeed of air through the rotors). Additionally, rotor speeds including relative rotor speeds are adjusted by the flight control system as part of adjusting the ratio of horizontal thrust to vertical thrust, and/or as part of adjusting effective overall thrust. Optionally, one or more control surfaces are provided, which may adjust the aerodynamic behavior of the aircraft in response to air flowing over it, and/or adjust (e.g., divert) thrust by diverting airflow generated by rotors 5. In some embodiments, four rotors 5 are provided. In some embodiments, rotor 5 are powered electrically, i.e., by one or more on-board batteries. Other configurations of wings, motive units (e.g., engines of different type and/or number) and/or power sources are optionally provided in some embodiments of the present disclosure.

In some embodiments, the cockpit 7 of aircraft 1 is configured as a high-visibility cockpit, with transparent areas on either lateral side positioned at or below the waist level of a pilot seated within to allow good lateral visibility of the ground. In some embodiments, forward lower window 8 provides viewing area at or below the waist level of the pilot, for example as described in relation to the cockpit 7 of FIG. 2C. Optionally or alternatively, visual monitoring of the ground is provided by a camera 9, e.g., an internally or externally mounted camera. Optionally, aircraft 1 carries one or more passengers in addition to the pilot (e.g., a passenger seated next to the pilot). For example, the load capacity of the aircraft is optionally 150 kg or more, 200 kg or more, 250 kg or more, 350 kg or more, or 500 kg or more. In some embodiments, the load capacity of the aircraft is within a range of 150-350 kg, or 100-400 kg.

It is noted that in the field of “short hop” (e.g., 120 km or less range) battery-powered aircraft in particular, there are important constraints on the aircraft load carrying ability and flight envelope introduced by the combined limitations of battery technology (e.g., power storage density) and/or electrical motor power-to-weight ratios. Insofar as the cruising time is relatively short, a larger fraction of the variability in energy expenditure that helps dictate the required reserve portion of the aircraft's energy budget is represented by the landing phase of flight. In some embodiments, aircraft 1 has a rated carrying capacity in the range of 200-300 kg, for flights of at least 30 minutes (e.g., 30 minutes, 45 minutes, or 60 minutes) and a maximum rated range between about 80 km and 150 km (e.g., in a range of 90-120 km).

Accordingly, it may be understood that the ability of an aircraft to be landed from cruising speed with reliably predictable use of energy reserves is potentially of major importance to its usability for flights extending to near the limits of its rated range. This reliable predictability be reflected in the consistency of time to landing and/or consistency of power levels used during the landing phase of flight, preferably even for pilots who are new to the use of the aircraft, and preferably without placing high concentration demands on the pilot, particularly when the pilot is also engaged in assessing the selection and/or condition of a landing site 3. Consistency does not necessarily mean that each flight is identical, but rather that the pilot can make a predetermined flight plan based on confident assumptions; e.g., that the actually expended landing time and/or energy budget will be within 10%, 20%, or 30% of predetermined expectations. For example, if the pilot expects that the time from cruising speed to landing site hover will be not use more than 10% of the total energy budget for the flight, they can consider that they will need at most 3% additional when deciding if their battery energy reserves are indeed safe. This may become an issue to the pilot, e.g., in making rapid decisions, and/or in assessing the acceptability of aircraft performance as a function of battery age, charge state, and/or weather.

In some embodiments, the difference in average landing energy budget expenditures over a range of pilots (e.g., the 95% nearest-average pilots out of a randomly selected population of pilots) with different skill levels (each operating according to the same predetermined landing parameters) is insignificant or negligible for planning compared to the effects of variability in other flight conditions such as weather; e.g., less than 50% or 25% of weather variability effects on energy expenditure during landing.

Reference is now made to FIG. 2B, which schematically illustrates relationships among horizontal (forward speed) and vertical (descent) speeds for a glide slope constant k, according to some embodiments of the present disclosure. The momentary ratio of descent speed 12 and forward speed 13 and is indicated as

$$\frac{{v}_{V}}{{v}_{H}} = k ,$$

and the momentary ratio or forward deceleration 24 and descent deceleration 25 is indicated as

$$\frac{{a}_{V}}{{a}_{H}} = k .$$

So long as k is held constant, the aircraft remains on the same glide slope (e.g., a slope in the range between glide slope 22A and glide slope 22B, although shallower or deeper glide slopes are not excluded).

Glide slope 22B again indicates a glide slope of about 10°, with k=0.18 (approximately). To maintain this slope, the ratio of forward speed 13B must be kept (at least on average) in proportion with descent speed 12B; e.g., by applying deceleration towards landing such that forward deceleration 24B descent deceleration 25B are also maintained at the same ratio. For a steeper glide slope 22A, a different ratio (of forward speed 13A and descent speed 12A, and of forward deceleration 24A and descent deceleration 25A) is maintained; e.g., k=1.75 (approximately).

### Cockpit Viewing and Control of Glide Slope-Controlled Descent to Landing

Reference is now made to FIG. 2C, which schematically illustrates direct-stick adjustment of glide slope constant k, from the perspective of a cockpit 7 of aircraft 1, according to some embodiments of the present disclosure.

During descent to landing, in some embodiments of the present disclosure, a pilot sets the current value of k (corresponding to the glide slope 4) using a flight controller 505. For example, pushing forward on flight controller 505 leads to an increase in k, and, accordingly, a steeper rate of descent. Pulling back on flight controller 505 leads to a decrease in k, and, accordingly, a shallower rate of descent.

Movements of flight controller 505 are optionally interpreted as relative (e.g., indicating a rate of change relative to current status), or as absolute (e.g., the position of the flight controller 505 is directly converted to a value which sets a parameter such as glide slope). Hybrids of these are possible, e.g., a middle range of flight controller 505 movement interpreted as absolute relative to some set point (e.g., a certain altitude), with rate-of-change control at extremes of controller motion range that also modifies the set point used when the controller is returned to its middle range of motion.

Since aircraft response generally lags inputs, the “absolute” mode of operation may be understood as a setting a control value which is targeted. The flight control logic of the aircraft is preferably configured to handle transitions inn flight control mode such that the position of the flight stick pre-transition is not interpreted post-transition in a manner which results in jarring changes to aircraft flight. This may include gradual transitions of flight controller axis interpretation, e.g., gradual changes between relative and absolute control modes, and/or gradual changes in the interpretation of flight controller position as the aircraft transitions between flight control modes.

It should be noted that the direct coupling of a control axis of flight controller 505 to k and glide slope 4 is preferably a special mode of aircraft operation. For example, during cruising flight, the same axis is optionally matched to another directly controlled parameter; for example, rate of climb, aircraft pitch, throttle, or a combination of any two or more of these.

A glide slope during aircraft landing is ordinarily affected by the positioning of a flight controller 505, insofar as, e.g., an aircraft's flight surfaces are modified by its operation. However, it is emphasized that the actual resulting glide slope is ordinarily subject to additional factors (importantly, the air speed of the aircraft), which a skilled pilot must maintain in balance with the inputs provided through the flight controller 505 in order to keep the aircraft on course. In embodiments of the present disclosure, the aircraft itself is responsible for maintaining this balance.

For an airborne aircraft, in general, to “go where it is pointed”, is neither given, nor a default. During landing operations in particular, fixed wing aircraft generally point away from the ground. Also in embodiments of the present disclosure, it should be understood that selecting the glide slope is distinct from selecting the attitude (and in particular the pitch) of the aircraft so that it corresponds to the glide slope. In some embodiments, even with the flight controller 505 held steady, the aircraft pitch may be varied as part of the aircraft's efforts to maintain forward speed and descent speed in constant ratio.

The time from the moment a pilot begins adjusting glide slope to aim at a target to a moment when the aircraft reaches a glide slope consistent with reaching the target (if thereafter maintained) is potentially a few seconds, e.g., the aircraft aims itself toward the landing site within 1-20 seconds. Optionally a longer time is taken, e.g., to restrain the dynamics of the aircraft. To adjust rapidly, it may be particularly suitable for an aircraft largely dependent on rotor lift to decrease rotor thrust as needed to increase the speed of vertical descent. Following establishment of the glide slope, the pilot preferably remains free to indicate updating corrections as appropriate for the rest of the flight (e.g., until reaching the terminating speed/terminating height). Optionally, updating corrections from the pilot indicate no change if the initial course is correctly set and conditions otherwise remain stable.

If the pilot is mistaken in the initial indication of the glide slope, the pilot may be initially satisfied that the glide slope is correctly established, but realize upon further descent that the landing site is not being directly approached (e.g., it is drifting in the view). The pilot may then naturally enter into a phase of providing indications of corrections to the aircraft, e.g., according to what the pilot perceives will stabilize the angular position of the targeted landing site. Optionally there are no strong restrictions on the allowed magnitude of indications, e.g., to allow changing the selected landing site. Optionally, the aircraft control systems reduce sensitivity of the system to pilot indications of corrections after an initially apparently stable selection is made, e.g., to promote the ability of the pilot to make fine corrections without over-correcting.

With steep descent slopes (e.g., including angles from 10°-60° below horizontal), it is a potential advantage for an aircraft to provide to a pilot direct forward visibility at low angles. In some embodiments of the present disclosure, this is provided by a forward lower window 8 that extends upwards from about the level of the feet 501 of the upright-seated pilot. In some embodiments, a footrest 501A defines this level. In level flight, in other word, the window includes a viewing area which is beneath the horizontal plane of the pilot's waist.

Accordingly, a targeted landing site 3 on or near the current glide slope 4 of the aircraft 1 will often appear to the pilot as lying beyond forward lower window 8.

In the example of FIG. 2C, the present heading of aircraft 1 is at the intersection of horizontal line 503 (indicative of the ROC of aircraft 1), and vertical line 502 (its bearing). Since an aircraft does not necessarily “point” at its present heading, this intersection is not necessarily in a consistent or predetermined location in the pilot's field of view. Instead (and for a constant pitch α of the aircraft): as k is adjusted up and down, the effect on glide slope is as though horizontal line 503 (and so, the aircraft's projected “point of contact” with the ground) is adjusted correspondingly (but inversely) down and up (represented as the −k with arrows in the figure). “Down and up”, in this case, also corresponds to “closer and further”, since the ground is being observed from an oblique angle.

In some circumstances, the pitch α is also varied as k changes, or varied otherwise, e.g., as speed decreases. This alone could result in a significant change in the viewport position (angle relative to the pilot) of the intersection of horizontal line 503 and vertical line 502, even though it has no direct bearing on the ground position of this intersection.

Although the pilot cannot in general determine the currently targeted landing site merely from its present relative angular position in the pilot's vision, the pilot may be able to perceive the targeted landing site (the current ground-pointing heading of the aircraft) from the general pattern of optical flow in its vicinity (e.g., as indicated by arrows 504). If this location is stable (e.g., without side-slip, changes in aircraft attitude, or changes in glide slope itself), it will be angularly fixed but “growing”, while other regions move outward from it. However, at larger distances and/or lower speeds, the center of optical flow may be difficult to determine perceptually.

The pilot can nevertheless readily and intuitively keep the aircraft closing with visually monitored landing site 3, even if only by operating the flight controller 505 to keep the apparent (angular) position of targeted landing site 3 constantly positioned, wherever it is (as long as there is a net closing of distance, and no shift in pitch required to reduce speeds). If a shift in pitch occurs, the pilot may maintain allow the angular position of landing site 3 to move, accounting for the shift occurring, but not necessarily knowing its precise magnitude. Movement of the horizon, for example, provides an intuitive visual cue that a pitch change is occurring. At least during gentle deceleration, the sense of balance also provides a sensory cue.

Even if the momentary direction of aircraft 1 is consistently off course (e.g., due to pilot misperception of the true heading), constant pilot correction will gradually curve the aircraft toward the intended landing site. Even though, e.g., a 15° error in perceived heading is drastic at a distance of several kilometers, constant correction during final approach will result in absolute error being reduced over time. By the time the aircraft has closed to within a few meters of the landing site, the same 15° error is much less significant—and by then, the pilot will generally find it easier to determine intuitively and by sight the true heading of the by then much-slowed aircraft, and adjust corrections accordingly.

Also shown in FIG. 2C is flight instrument panel 506. In some embodiments, this displays information which the pilot may additionally or alternatively use to locate and/or confirm the currently targeted landing site location. For example, the flight navigation computer may perform calculations to determine the currently targeted point of intersection with ground, and optionally display this to the pilot as a map. In another example, the flight navigation computer optionally shows a representation mimicking the view of the pilot, indicating the pilot-subjective direction of the currently targeted point of intersection with ground. In another example, lighting (e.g., points, crosshairs, text, and/or graphical symbols) is projected onto the forward lower window 8 itself, and controlled so as to indicate the pilot-perceived location of the currently selected point of intersection with ground.

Optionally or alternatively, the navigation system may use the pilot's navigation inputs to help determine where the pilot is trying to head (e.g., what point in the distance is being held at a constant angular position). If this does not coincide with the present course of the aircraft, the pilot may receive suggestions from the system to adjust course. Optionally, the navigation system may itself adjust aircraft operation to assist the pilot. In some embodiments, the navigation system's estimate of pilot intentions may be presented to the pilot, and the pilot given the opportunity to confirm or correct this estimate.

In some embodiments, once pilot and navigation system have mutually confirmed the targeted landing site, additional functions may become available. For example, the navigation system optionally itself controls flight operation to reach the targeted landing site (if the pilot allows), and/or suggests to the pilot a faster and/or more energy efficient course to reach the target landing site. In some embodiments, the flight system uses its available map and/or sensing data to evaluate the targeted landing site; e.g., to determine the presence of obstacles potentially not yet visible from the air, verify that the landing site is reasonably level, check if the landing site is potentially vulnerable to conditions of avalanche or landslide, and/or check if there is a known problem with landing rights. Optionally, these checks are performed on the presently targeted point of course intersection with ground, even if the pilot has not explicitly confirmed it is a targeted landing site.

### Function-Based Parameter Control During Glide Slope-Controlled Descent

### Common Function Constraints

Reference is now made to FIG. 2D, which illustrates equations 201, 201B relating forward speed v_{H}, ROC v_{V}, aircraft height h (height above landing zone), glide slope constant k, and velocity function ƒ(h), according to some embodiments of the present disclosure.

Equation 201 lim (h→h_{offset}) v_{H}=0 indicates the end-condition of the glide slope: a zero forward velocity v_{H} (or nearly zero, e.g., less than 1 m/sec) as aircraft height h approaches some height above ground h_{offset} from which final (vertical or nearly vertical) landing is completed.

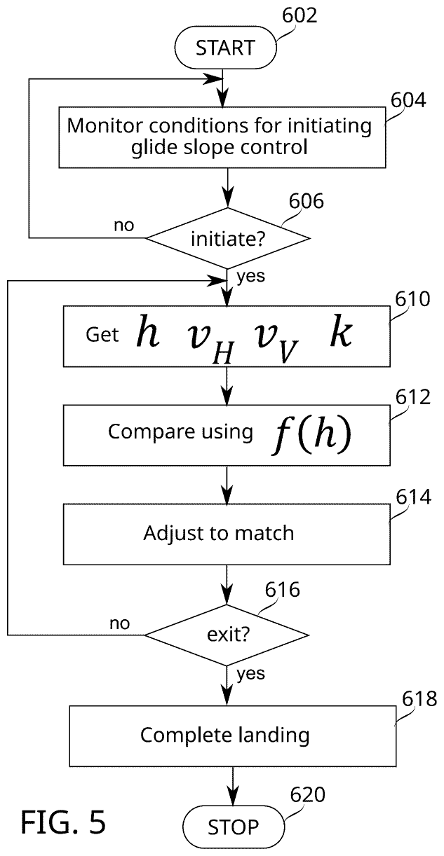

Equation 201B v_{V}=kv_{H}=ƒ(h) indicates the glide-slope equation of FIG. 2B written in different form, and equated to a function of height ƒ(h). This function may be used by a flight control system of aircraft 1 to regulate aircraft speeds during descent as a function of height as such. In some embodiments, other factors are used to modify ƒ(h) and/or as a proxy for height, for example as discussed in relation to FIG. 5.

### Speed Reductions as a Function of Height

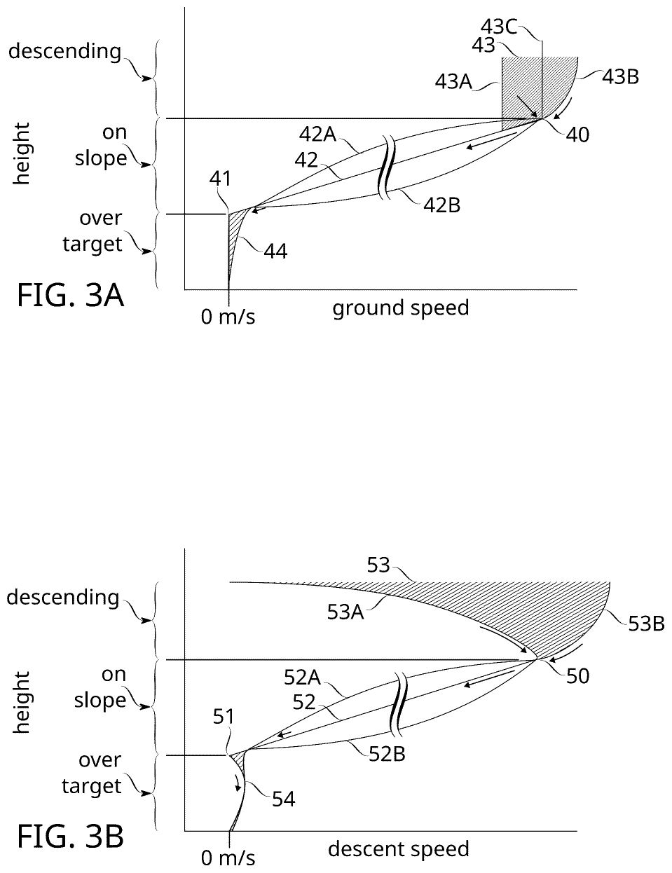

Reference is now made to FIG. 3A, which schematically illustrates relationships of ground speed to height during landing approach of a vertically landing aircraft 1, according to some embodiments of the present disclosure. Further reference is made to FIG. 3B, which schematically illustrates relationships of descent speed (negative ROC) to height during landing approach of a vertically landing aircraft 1, according to some embodiments of the present disclosure.

This reflects implementation of two control loops: One for ROC and one for forward speed. For example, forward speed is optionally a linear function of height above ground, offset by a certain minimum height at which the minimal speed is reached and/or glide slope control mode is exited). There is also a maximum height above which speed does not increase.

ROC shares these features, e.g., it is also a maximum above a certain height, and reaches zero—at least at landing, and optionally at the offset height, at which point the pilot optionally receives direct control of height (e.g., replacing control of descent slope), with enough time to react to conditions as appropriate. In some embodiments, this may be thought of as manipulating ROC in real time using the stick: pushing the stick forward increases (in the negative direction) ROC-which makes the approach steeper, and vice versa. For linear decelerations as a function of height: a steeper approach more quickly (as a function of time) decreases both forward speed and speed of descent (e.g., the aircraft reaches the ground and the projected minimum forward velocity sooner). However, compared at any given height, a steeper approach descends more quickly than a shallower one, while forward speed is optionally the same. Linear deceleration is not necessarily maintained in all embodiments.

Beginning with FIG. 3A: the three paths 42, 42A and 42B leading between on-slope point 40 and final landing speed/height envelope 44 represent a range of different relationships between height and ground speed (horizontal/forward flight speed). Path 42 represents a linear height/speed relationship, wherein horizontal speed is reduced proportionally as a function of decreasing height along a certain glide slope. Optionally, path 42 represents this relationship at any selected glide slope. In such a case, the rate of deceleration is larger, the steeper the glide slope.

However, there is no particular requirement that the relationship between ground speed and height be linear. Path 42A represents a case where speed is slowed earlier (“faster”) than in the linear case. This increases time to landing, but potentially provides more opportunity to observe (and possibly refine or change) a targeted landing site. Path 42B represents a case where speed is maintained longer than in the linear case. This shortens time to landing. Such a pattern may be suitable to conserve available energy, and/or when the pilot is confident in the suitability of the landing site.

It should be noted that all of paths 42, 42A, and 42B (including paths located between them) are consistent with maintaining a constant glide slope (even the same constant glide slope). Alternatively, the glide slope could be modified during descent without necessarily diverting from a given relationship between height and forward speed. In some embodiments, the “aggressiveness” of a descent is used to select which particular relationship between ground speed and height is used. For example, a steeper descent slope (already faster decelerating on linear path 42) may be linked to fast-decelerating path 42A, potentially adding a margin of safety, and perhaps allowing extra time to evaluate the landing site. Speed reduction for a shallower descent may be postponed as a function of height (as for path 42B), e.g., to avoid unduly extending flight length.

Alternatively, deceleration as a function of height is optionally more delayed for sharp descent, consistent with the sharp descent being interpreted as indicating a particular hurry to reach the landing site. Conversely, a shallow descent angle may single greater speed reduction, e.g., as if the shallow descent angle signals interest in loitering for observation of the area.

Optionally, a plurality of modes of deceleration are available, and a navigation computer of the aircraft 1 gives a pilot the opportunity to select what is suitable for their situation. Optionally, the pilot is able to select the height/speed relationship, e.g., by selecting an exponent factor which converts from linear to “super-linear” (e.g., path 42A) or “sub-linear” (e.g., path 42B) deceleration profiles. Optionally, this selection is performed according to the setting of a throttle input; e.g., squeezing a throttle trigger more biases the height/speed relationship so that it speed reduces more slowly as a function of height (i.e., from whatever its current value is).

It is noted again that the choice of glide slope k is under the dynamic control of the pilot (e.g., by movement of a flight controller axis), and is optionally modified at any point during descent, e.g., to select a new landing site. In case this k is tied to the speed-height function, the aircraft may optionally interpret this as a command to speed up or slow down as necessary to match the “new” path. Alternatively, the aircraft may slow down but not speed up, simply continue using the originally selected relationship between ground speed and height, or make a partial transition, e.g., according to how much speed and/or height remains to be shed.

The vertical descent of line 43C represents reduced height at a forward cruising speed, until some threshold height is reached at which the aircraft transitions to glide slope control (e.g., direct pilot selection of glide slope by operation of a flight controller axis). However, the entry into glide slope control may occur otherwise. Area 43 indicates a range of paths which could lead to the glide slope control transition. A direct descent at constant sub-cruising speed along line 43A, for example, may cause the height/speed relationship to be triggered only when actual forward speed intersects the height/speed function to be used during landing descent. Alternatively, path 43B represents descent from an over-speed condition. Optionally (even while glide slope control is not yet enabled) a height-speed relationship is carried to higher altitudes to help ensure a smooth transition. Alternatively, deceleration is begun only once glide slope control is enabled (e.g., below the height of point 40). In another option, the height-speed relationship is simply scaled to the current speed once the aircraft enters glide slope control mode. In another option, entry into glide slope control mode itself happens at a higher or lower altitude, so as to allow initial deceleration to begin earlier or later as appropriate.

Final landing speed/height envelope 44 represents that forward velocity might actually be brought to 0 above the landing target before a truly vertical descent, or there may be a continuing slowing from a low but non-zero forward as the aircraft completes landing. Although the graph does not show non-zero forward speeds at landing (rolling), this is not excluded.

The points made for paths 42, 42A, 42B of FIG. 3A apply generally as well to paths 52, 52A, 52B of the height-to-descent speed graph of FIG. 3B, changed as appropriate. In the scenarios shown, it is contemplated to be more likely that initial rate of descent (e.g., in region 53, bounded by paths 53A and 53B) does not closely match a given glide slope initially selected by the pilot. As for the case of forward speed, this can be handled in various ways. The option shown adjusts descent speed as the aircraft descends toward the on-slope condition at point 50 to match some appropriate “starting” value (e.g., as determined will have an appropriate ratio with the current forward speed). Pilot inputs after point 50 are then interpreted relative to whatever value is reached. Optionally, there is no such preliminary matching, and whatever descent speed is current at the glide slope control transition simply becomes (according to its ratio with forward speed) the initially selected glide slope. Otherwise, the height-speed relationship is optionally handled as described for the ground speed vs. height graph. At landing, descent speed must be above zero until ground contact.

### Maneuvering and Pilot Cues During Landing Descent

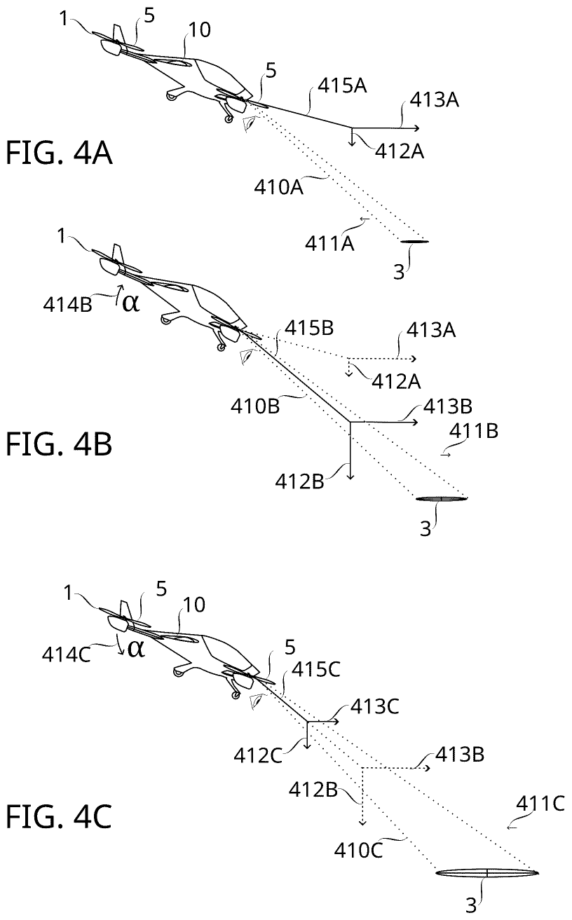

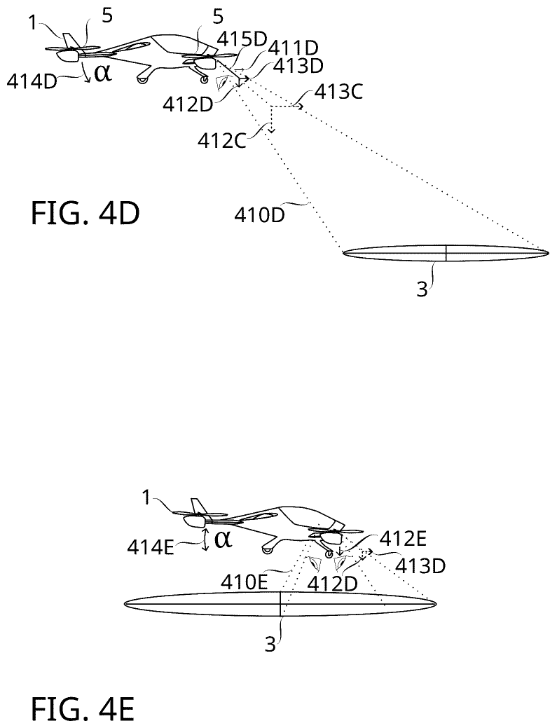

Reference is now made to FIGS. 4A-4E, which schematically illustrate phases of a landing approach of a vertically landing aircraft 1, according to some embodiments of the present disclosure.

In FIG. 4A, aircraft 1 is in forward flight with forward velocity 413A and descent velocity 412A, resulting in glide slope 415A. In some embodiments, aircraft 1 is a fixed-rotor, fixed-wing aircraft, with dynamics such that at higher forward speeds, a significant fraction of lift is generated by wing 10. Moreover, the pitch of aircraft 1 adjusts the proportion of thrust produced by rotors 5 which contributes to lift (vertically), and forward velocity (horizontally). The pitch may also affect total thrust, e.g., according to differences in airspeed in the horizontal and vertical directions. This interplay of dynamics is potentially complex in terms of direct effects on aircraft speeds. However, during direct glide-slope control by the pilot, the pilot is buffered from this complexity by the flight control systems of aircraft 1.

The nature of the control of the aircraft by the pilot, in some embodiments, is modal. For example, there is optionally a mode change from cruising flight to final approach (glide slope-controlling), and optionally a mode change from glide-slope controlling mode to vertical descent. It should be understood that there may be other flight modes such as for take-off, ascent to cruising flight, and/or sport flight. Optionally, one or more of the modal changes is automatic, e.g., a change from cruising flight mode to glide-slope controlling mode triggered as the aircraft descents below a certain altitude. Optionally, a flight mode change can be induced or reversed (e.g., reversing an automatic change) by the pilot, at least in some circumstances. Modal changes may be immediate, but not necessarily. For example, the meaning of pilot input to a certain axis of the flight controller 505 may be smoothly varied to gradually reduce its effect as interpreted to indicate thrust level directly, while gradually increasing its effect as interpreted to indicate changes in glide slope.

In the situation shown, the pilot perceives landing site 3 at a distance, with the angular size and direction 410A. Angular size and distance-to-landing site are not to scale, but angular size is “at its smallest” in this figure, and distance the greatest. Since the glide slope 415A is not within the angular position of landing site 3, the aircraft 1 is overshooting, as indicated by right-pointing arrow 411A. Perceptually, the pilot may recognize this overshoot as a tendency for landing site 3 to drift lower/nearer in their lower field of view.

The situation of FIG. 4A may correspond to a pre-landing phase of flight, before a mode enabling direct pilot control of glide slope is enabled. In this case, glide slope 415A is the result of the otherwise commanded flight state of aircraft 1; e.g., as a result of pilot inputs to adjust thrust and/or pitch of aircraft 1.

Additionally or alternatively, the situation of FIG. 4A may correspond to phase of flight in which a mode enabling direct pilot control of glide slope is enabled (e.g., at pilot request and/or as a result of descending to a mode-initiating altitude), but the pilot has not yet aimed aircraft 1 at its eventual landing site.

By the time of FIG. 4B, direct pilot control of glide slope is enabled, and the pilot has moved a glide-slope controlling axis of flight controller 505 to adjust glide slope 415B so that the aircraft's glide slope coincides with the (now somewhat larger) visual angle 410B subtended by landing site 3. In this case, descent is at 45°, with equal forward speed 413B and descent speed 412B.

Optionally, pilot inputs to control glide slope have resulted in consequent angular changes 414B to the pitch α of aircraft 1. For example, the flight control systems of aircraft 1 may respond to pilot inputs depressing the glide slope by: (1) reducing thrust to increase descent speed 412B, and (2) increasing the fraction of rotor thrust provided in the forward direction so that forward speed 413B is maintained in the pilot-commanded ratio k with descent speed 412B. During pitch adjustment, the pilot may, accordingly, experience landing site 3 drifting (e.g., upward/distant, in this case) in their lower field of view, despite that aircraft 1 is actually on a glide path directly to landing site 3. However, potentially, any pitch adjustments in immediate response to pilot inputs modifying the glide slope are rapid enough that the pilot can attribute them to their own inputs; these may cease as soon as the pilot stops making glide slope changes.

In FIG. 4C, glide slope 415C remains within the visual angle 410C subtended by the targeted landing site 3, while forward speed 413C and descent speed 412C have again reduced in a constant ratio.

However, pitch α has reverted more toward a horizontal orientation as indicated by arrow 414C, even though the pilot-commanded glide slope 415C remains unchanged and centered within the angle 410C subtended by landing site 3. This may be a result, for example, of the efforts of the flight control systems of aircraft 1 to continue reduction in forward speed 413C and descent speed 412C in a constant ratio. For example, the amount of lift provided by wing 10 may now be sufficiently reduced that a larger contribution to vertical thrust is needed from rotors 5. To avoid increasing forward thrust, aircraft 1 tilts back toward the horizontal.

In some cases, automatic pitch adjustments performed as part of speed reductions corresponding with lowered height may give the pilot a stronger illusion of course drift (e.g., in the nearer/lower direction of arrow 411C). However, the pilot may intuitively perceive a difference between the whole visual field shifting (as in a change in pitch), and a shift in the stable part of the visual field (as in a change in glide slope as such). Moreover, as landing site 3 approaches, it may become easier to confirm that landing site 3 remains at the center of optical flow in the approaching ground. Nonetheless, even if the pilot erroneously tries to “correct” an illusion to the contrary, their continued intuitive focus on stabilizing the angular direction of landing site 3 still leads the aircraft to the intended destination.

Again in FIG. 4D, glide slope 415D remains within the visual angle 410D subtended by now-nearby targeted landing site 3, while forward speed 413C and descent speed 412C are again reduced in a constant ratio. At this point, the angular size of landing site 3 (and visual angle 410D) has expanded enough that it may be partially obscured for the pilot, but they can see enough of the surroundings and/or the landing site 3 itself to maintain their orientation.

The aircraft pitch α is further adjusted by angular change 414D, and now places rotors 5 horizontally or nearly horizontally, optionally with slight adjustment (e.g., back-tilting) as appropriate to continue cancelling forward speed 413D. The pilot by now has strong visual cues as to their absolute motion relative to landing site 3, potentially preventing illusory effects which confuse as to the glide slope of the aircraft.

In the situation of FIG. 4E, aircraft 1 has reached the end of its glide path: it is fully over the landing site 3, with forward velocity canceled, and descent speed 412E from now on maintained at low level to produce a safe landing. In a static hover mode, all thrust is directed in the vertical direction, e.g., a is zero.

Optionally glide slope mode is now canceled. Optionally, the flight controller's motions in the axis that formerly set glide slope now guide the descent speed 412E of aircraft 1. The pilot can now look in several directions (e.g., including to the sides of aircraft 1) to monitor the position and/or state of the landing site 3 (e.g., within angular range 410E). The flight controlling systems of aircraft 1 optionally provide angular adjustments 414E to pitch α in small amounts as appropriate to provide station keeping over the present ground position.

Optionally, the transition from glide slope mode to final vertical descent mode is performed in a blended (gradual) fashion, such that the glide slope response of aircraft 1 to change in the position of flight controller 505 becomes gradually weaker (e.g., as a function of height above ground), in favor of vertical position and/or speed. This change may be asymmetric; e.g., it may happen faster in the descent-increasing direction, but in the other direction may lag to allow the pilot control to creep forward without necessarily increasing height (or without increasing it as significantly).

### Operations of Glide Slope Control Mode

Reference is now made to FIG. 5, which is a schematic flowchart of a method of controlling the landing approach of a vertically landing aircraft 1, according to some embodiments of the present disclosure.

At block 602, the flowchart begins.

At block 604, in some embodiments, the aircraft flight control systems monitor aircraft state and/or pilot inputs to determine if conditions are met for initiated glide slope control of the aircraft. Optionally, glide slope control is initiated by explicit pilot instruction. Conditions for automatic switching optionally include descent below a certain altitude, optionally predicated on previous events such as a period of travelling at cruising speed above that altitude. In some embodiments, an emergency switch into glide slope control mode is initiated under circumstances such as low remaining battery charge (and/or otherwise restricted energy reserves), and/or detected damage and/or malfunction (e.g., of a rotor).

From block 606, in some embodiments, if conditions to initiate glide slope control mode are met, the flowchart proceeds to block 610. Otherwise, flow returns to block 604.

At block 610, in some embodiments, the aircraft height h, forward (horizontal) speed v_{H}, descent (vertical) speed v_{V} and currently pilot-commanded glide slope k are accessed. In some embodiments, the pilot-commanded glide slope k is provided according to movements of a flight controller, e.g., movements of a particular axis of the flight controller.

The flight controller (e.g., flight controller 505) optionally has a plurality of control axes; e.g., a main axis for each of left/right and forward/backward movements of a control stick, a rotating axis (e.g., around a geometrical axis extending through a longitudinal axis of the control stick), and one or more secondary axes, e.g., directionally placed selection switches, a two-axis “hat” joystick, one or more throttle axes, and optionally one or more buttons. Preferably, the main forward/backward movement axis of the flight controller become the direct control axis for glide slope once glide slope control is initiated. Optionally, another axis (e.g., an axis of a two-axis “hat” joystick) is used instead. The glide slope control axis is optionally interpreted as signally glide slope relatively, absolutely, or a blend of these; e.g., as described in relation to FIG. 2C.

At block 612, in some embodiments, the values accessed at block 610 are compared through a function ƒ(h), which may be constructed, for example, according to any of the principles described in relation to FIGS. 3A-3B. Optionally, additional inputs from the pilot modulate ƒ(h), e.g., modulating whether deceleration occurs slower or faster early on. Optionally other factors modulate ƒ(h), e.g., time of flight, current speeds, current distance to ground (e.g., along the current glide path), distance to a previously targeted landing site, or another factor. Moreover, it should be understood that “height” as the independent variable of the speed function is optionally replaced by one or more parameters such as target time to landing, or remaining distance to landing site. Conversely, “height” may be understood as a proxy for such parameters and/or combinations of parameters. However, height as such has a particular prominence insofar as the end condition of landing is a zero height above ground. Height itself may be defined in various ways, e.g., as described in the overview, and optionally the definition used is changed dynamically during landing as appropriate, e.g., according to the proximity of the landing site and/or characteristics of intervening terrain.

Potentially, there is a discrepancy between the speed(s) indicated by applying ƒ(h) and the actual speed(s) of the aircraft. For example, the aircraft may enter glide slope control mode at a speed and altitude which are not on the height/speed function. Optionally, this is avoided by scaling the function ƒ(h) to match present flight parameters, and speed reductions proceed from there. Optionally, excessive deviation prevents entry into glide slope mode, and/or causes an exit from glide slope mode. In some embodiments, the function ƒ(h) is defined to allow entry at several different combinations of parameters, optionally with suitable “funneling” to adjust aircraft flight parameters toward a standard flight envelope used during glide slope control mode.

In a fully relative mode, discrepancy between the commanded value of k and the actual ratio of v_{V} and v_{H} is optionally avoided by treating the position of the flight controller axis as indicating a commanded rate of change in k (from whatever it presently is). This has the potential advantage of allowing a centered stick position (optionally with surrounding non-responsive “dead zone”) to indicate no commanded change, which can help the pilot interpret their sensory perceptions. A commanded rate of change may not be achievable instantaneously, e.g., due to response lags, but the pilot can wait for cumulative effects.

However, in some embodiments the position of the flight controller axis indicates (at least 2.5 in part) a targeted value of k. In that case, the target of control by the aircraft flight control system is to reduce the discrepancy in commanded vs. actual k over time.

As noted, e.g., in relation to FIGS. 3A-3B, there are optionally a range of different functions of height and speeds along which an aircraft may proceed from a given present height and speed. The range is optionally selected from automatically or by choice of the pilot. Optionally, the range is selected from by predetermined choice. Optionally, the range is selected from dynamically, e.g., according to present conditions and/or changes in pilot inputs.

At block 614, in some embodiments, current flight characteristics of the aircraft are adjusted as appropriate in order to bring the expected measurements of aircraft height h, forward (horizontal) speed v_{H}, descent (vertical) speed v_{V} and currently pilot-commanded glide slope k into closer or continuing mutual consistency with respect to ƒ(h). In general, glide slope controlled flight converts pilot commands selecting and/or changing the glide slope k as such into aircraft flight parameter adjustments which produce and/or lead toward a matching actual ratio of v_{V} and v_{H}, e.g., by suitable adjustments of thrust, aircraft pitch, and optionally other parameters such as airfoil shape adjustments, activation of secondary thrusters, and/or movement of thrust diverting surfaces.

At the same time, v_{V} and v_{H} are reduced so as to reach v_{V}=0 (at least approximately) upon reaching some offset height h_{offset} above or at ground level. As noted hereinabove, the reduction may be linear, or it may follow another function. There may be several different but concerted changes occurring to aircraft flight parameters occurring at once-some affecting one of the two speeds nearly independently of the other, and some resulting in closely correlated (or even anti-correlated) changes to forward speed and speed of descent.

Where consistency with ƒ(h) is already established, the adjustments of block 614 may comprise maintaining current flight characteristics (e.g., continuing an existing rate of reduction of motor power), and/or adjusting them gradually, e.g., incrementally adjusting aircraft pitch as appropriate for the current relative contributions to vertical lift of an aircraft wing and aircraft rotor thrust. Where discrepancies are larger, the adjustment may be made suitably more abrupt, e.g., according to considerations of the margin of safety and/or flight comfort.

At block 616, in some embodiments, an automatic (or optionally manual) determination is made as to whether glide slope control mode should now be exited (e.g., because the aircraft has reached the conditions of vH=0 and h=h_{offset}). If not, the flowchart continues with block 610. Otherwise, the flowchart continues at block 618 with the completion of landing. For example, once minimum height (of the glide slope, that is, h_{offset}) is reached, the flight control system of the aircraft transitions automatically to “hover mode”, which holds height above the ground (ROC=0) 5 unless the pilots requests otherwise, and allows the pilot to move the aircraft laterally (e.g., left/right and optionally forward/backward) to fine tune the exact touchdown point.

At block 620, after landing, the flowchart ends.

### Flight Control System Supporting Glide Slope Control Mode

Reference is now made to FIG. 6, which schematically illustrates a flight control system 650 of a vertically landing aircraft 1, according to some embodiments of the present disclosure. Elements of flight control system 650 specifically related to glide slope control are emphasized; however, it should be understood that landing control system 650 comprises capabilities for controlling flight of aircraft 1 overall.

Flight computer 651, in some embodiments, comprises a computer processor and memory storing instructions to be carried out by the computer processor to control flight characteristics of the aircraft 1. Elements of aircraft 1 other than landing control system 650 are described, for example, in relation to FIGS. 2A and 2C, herein.

Flight computer 651 determines the current flight status of the aircraft from a suitable combination of data received from position/speed sensors 652, other aircraft status sensors/actuators 654, motors 656, and/or map data 657. Position/speed sensing (including altitude and aircraft attitude sensing, e.g., pitch, yaw/bearing, and/or roll), may use any suitable technology or combination of technologies, e.g., GPS, radio beacon, inertial tracking, magnetic compass, air pressure, pitot tube, and/or MEMS. Aircraft status sensors may provide data on, e.g., temperature, battery charge remaining, flight time, cabin pressure, equipment operational status, or any other data relating generally to the functioning of the aircraft. In particular, motors 656 may provide information on their present torque and/or rate of spin, e.g., as indications of thrust and/or performance. In some embodiments, map data 657 is used to place sensor data into context; e.g., to determine current absolute altitude and/or predict altitudes along a present or projected course. The “actuator” portion of aircraft status sensors/actuators 654 (optional in some embodiments) provides information on the position of actuators of the aircraft as appropriate, e.g., the positions of movable flight control surfaces, as applicable.

In some embodiments, the memory of flight computer 651 includes parameters describing targeted state information 659, which computer 651 uses to determine whether and what adjustments may be needed to the operation of motors 656, and/or of the actuators of aircraft status sensors/actuators 654 as applicable. Targeted state information 659 is in part predetermined, e.g., as parameters which specify how to respond to various patterns of data for correct flight in one or modes. For example, it may describe how pitch and thrust may be varied from present (controllable) state conditions in order to proceed toward new (flight) state conditions, e.g., as commanded by pilot inputs. Targeted state information 659 is also set in part via pilot inputs 660, which indicate to the flight computer what the pilot wants to do. This may take the forms, e.g., of autopilot settings, map selections, flight mode settings, and/or moment-to-moment inputs from a flight controller (e.g., joystick). The targeted state information 659 may also describe conditions for switching flight modes, e.g., from cruising flight to glide slope control mode for landing approaches, and from glide slope control mode to hover-and-descend mode for the final phase of landing.

During glide slope control mode (approach to landing site 3 along a course specified in part according to its slope), pilot inputs 660, in some embodiments, include glide slope input 662, provided, e.g., by a motion axis of a flight controller 505, e.g., as described in relation to FIG. 2C. Optionally, the deceleration profile of descent is modulated by deceleration modulation inputs 664, optionally mapped to an active control axis (e.g., a trigger used as a throttle input, or an airspeed selector input more generally). Additionally or alternatively, the deceleration profile of descent is set as a persistent parameter (e.g., a mode selection). Optionally, it is fixed, e.g., a linear deceleration selected as appropriate for reaching a targeted landing site at an offset above the ground. Deceleration profiles are discussed, for example, in relation to FIGS. 3A-3B. The pilot generally also controls other inputs 666 as appropriate; e.g., yaw and/or bearing are typically controlled by the flight controller 505. Other inputs 666 also optionally include, e.g., map selection and other navigational inputs, mode selections, and/or parameters governing how the flight computer 651 selects from among flight control options (e.g., responding with more or less sensitivity and/or abruptness).

### General

As used herein with reference to quantity or value, the term “about” means “within ±10% of”.

The terms “comprises”, “comprising”, “includes”, “including”, “having” and their conjugates mean: “including but not limited to”.

The term “consisting of” means: “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

The words “example” and “exemplary” are used herein to mean “serving as an example, instance or illustration”. Any embodiment described as an “example” or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the present disclosure may include a plurality of “optional” features except insofar as such features conflict.

Throughout this application, embodiments may be presented with reference to a range format. It should be understood that the description in range format is merely for convenience and brevity and should not be construed as an inflexible limitation on the scope of descriptions of the present disclosure. Accordingly, the description of a range should be considered to have specifically disclosed all the possible subranges as well as individual numerical values within that range. For example, description of a range such as “from 1 to 6” should be considered to have specifically disclosed subranges such as “from 1 to 3”, “from 1 to 4”, “from 1 to 5”, “from 2 to 4”, “from 2 to 6”, “from 3 to 6”, etc.; as well as individual numbers within that range, for example, 1, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween.

Although descriptions of the present disclosure are provided in conjunction with specific embodiments, it is evident that many alternatives, modifications and variations will be apparent to those skilled in the art. Accordingly, it is intended to embrace all such alternatives, modifications and variations that fall within the spirit and broad scope of the appended claims.

It is appreciated that certain features which are, for clarity, described in the present disclosure in the context of separate embodiments, may also be provided in combination in a single embodiment. Conversely, various features, which are, for brevity, described in the context of a single embodiment, may also be provided separately or in any suitable subcombination or as suitable in any other described embodiment of the present disclosure. Certain features described in the context of various embodiments are not to be considered essential features of those embodiments, unless the embodiment is inoperative without those elements.

It is the intent of the applicant(s) that all publications, patents and patent applications referred to in this specification are to be incorporated in their entirety by reference into the specification, to the same extent as if each individual publication, patent or patent application was specifically and individually noted when referenced that it is to be incorporated herein by reference. In addition, citation or identification of any reference in this application shall not be construed as an admission that such reference is available as prior art to the present disclosure. To the extent that section headings are used, they should not be construed as necessarily limiting. In addition, any priority document(s) of this application is/are hereby incorporated herein by reference in its/their entirety.

1. A method of automatic control of aircraft forward speed and descent speed during descent of the aircraft to a landing site, the method comprising:
adjusting a targeted glide slope of the aircraft in accordance with an updating indication of one or both of (a) corrections by a pilot to the targeted glide slope and (b) modifications by the pilot to said landing site;
adjusting automatically a ratio of the speeds to correspond with descent of the aircraft along the targeted glide slope as the targeted glide slope is adjusted and said landing site is modified; and
maintaining the ratio of the speeds in correspondence with the targeted glide slope and modified landing site while automatically reducing the forward speed from an initiating speed to a terminating speed;
wherein the initiating speed and terminating speed are different by at least half of the initiating speed of the aircraft.

2. The method of claim 1, wherein the terminating speed is less than 10% of the initiating speed of the aircraft and wherein the initiating speed is at least 80% of a design cruise speed of the aircraft.

3. The method of claim 2, wherein the terminating speed is stationary.

4-5. (canceled)

6. The method of claim 1, wherein the aircraft descends from an initiating height to a terminating height while slowing from the initiating speed to the terminating speed, and the ratio of the initiating height to the terminating height is within a factor of three of the ratio of the initiating speed and the terminating speed.

7-8. (canceled)

9. The method of claim 6, wherein, as a function of height, deceleration of forward speed includes decreasing deceleration for at least 10% of the difference between the initiating height and the terminating height.

10. The method of claim 6, wherein, as a function of height, forward speed decreases linearly on average for at least 90% of the difference between the initiating height and the terminating height.

11. The method of claim 6, wherein the terminating height is vertically within 2 meters of the landing site.

12. The method of claim 10, wherein the terminating height is vertically within 0.5 meters of the landing site.

13. The method of claim 11, wherein the terminating speed is less than 2 m/s.

14. (canceled)

15. The method of claim 13, wherein the terminating height and terminating speed are reached at a position over the landing site.

16. The method of claim 15, comprising hovering the aircraft at the position over the landing site.

17. The method of claim 1, wherein a time course of the updating indication of corrections includes:
a first phase in which the corrections result in modification of the targeted glide slope until a course of the aircraft descending along the targeted glide slope is aimed at the landing site; and
a second phase, following the first phase, in which the corrections maintain the course of the aircraft aimed at the landing site and descending along the targeted glide slope.

18. The method of claim 1, wherein a time course of the updating indication of corrections includes:
a first phase in which the corrections result in modification of the targeted glide slope until a course of the aircraft descending along the targeted glide slope is aimed at a location away from the landing site; and
a second phase in which the corrections adjust the course of the aircraft toward the landing site along an adjusted value of the targeted glide slope.

19. The method of claim 1, wherein the pilot communicates the updating indication of corrections by adjusting an axis of a flight controller.

20-25. (canceled)

26. The method of claim 1, wherein the updating indication of corrections is determined by the pilot according to a direct view by the pilot of the position of the landing site, at an angle declined by 10° or more from the horizontal.

27. The method of claim 26, wherein the updating indication of corrections is determined by the pilot according to a direct view by the pilot of the position of the landing site, at an angle declined by 30° or more from the horizontal.

28. The method of claim 26, wherein the direct view by the pilot of the position of the landing site is through a window portion positioned below waist level of the pilot within the aircraft.

29. The method of claim 26, wherein the direct view by the pilot of the position of the landing site is through a window portion positioned adjacent, from the viewing perspective of the pilot, to a footrest for the pilot.

30. The method of claim 1, wherein the updating indication of corrections is determined by the pilot according to a camera view of the landing site, at an angle declined by 30° or more from the horizontal.

31-49. (canceled)

50. The method of claim 1, wherein the aircraft comprises a computerized flight control system configured to maintain a fixed ratio between forward and vertical speeds of the aircraft while reducing both speeds toward stationary landing speeds as a function of the height above the ground.

51. The method of claim 1, wherein the adjusting the targeted glide slope comprises adjusting the landing site by a control stick.

52. A vertically landing aircraft having a computerized flight control system wherein the computerized flight control system is configured to:
adjust a targeted glide slope of the aircraft in accordance with an updating indication of one or both of (a) corrections by a pilot to the targeted glide slope and (b) modifications by the pilot to a landing site;
automatically adjust a ratio of a forward speed to a descent speed to correspond with a descent of the aircraft along the targeted glide slope as the targeted glide slope is adjusted and said landing site is modified; and
maintain the ratio of the speeds in correspondence with the targeted glide slope and modified landing site while automatically reducing the forward speed from an initiating speed to a terminating speed,
wherein the initiating speed and terminating speed are different by at least half of the initiating speed of the aircraft.

53. The vertically landing aircraft of claim 52, wherein the computerized flight control system configured to maintain a fixed ratio between forward and vertical speeds of the aircraft, while reducing both speeds toward stationary landing speeds as a function of the height above the ground.

54. The vertically landing aircraft of claim 53, including a transparent window oriented to face downward toward the ground from the perspective of an upright-seated pilot of the aircraft, and through which a landing area reached upon reaching stationary speeds is viewed during descent and the speeds reduction.

55. The vertically landing aircraft of claim 53, including a camera oriented to face downward toward the ground; and a display presenting a pilot of the aircraft a view of in which a landing area reached upon reaching stationary speeds is viewed during descent and the speeds reduction.

56. The vertically landing aircraft of claim 55, comprising a control stick, wherein the fixed ratio defines a position of a target landing area, and the fixed ratio is selected according to adjustments by the control stick movements.

57. The vertically landing aircraft of claim 56, wherein the target landing area is adjustable by altering an angle of descent in response to the control stick movements, the altering comprising replacing the fixed ratio with a ratio corresponding to the altered angle of descent.
